(19) United States
(12) Patent Application Publication
(10) Pub. No.: US 2026/0288298 A1
(43) Pub. Date: Sep. 24, 2026

(54) SYSTEM

(71) Applicant: SoftBank Group Corp., Tokyo (JP)

(72) Inventor: Shiho ONO, Tokyo (JP)

(73) Assignee: SoftBank Group Corp., Tokyo (JP)

(21) Appl. No.: 19/568,906

(22) Filed: Mar. 17, 2026

(30) Foreign Application Priority Data
Mar. 19, 2025 (JP) 2025-045184

(51) Int. Cl. G06F 3/04815; G06F 3/01; G06F 40/186; G06F 40/40; G06T 19/00; G06V 10/82; G06V 40/16; G10L 25/30; G10L 25/63

(52) U.S. Cl. CPC G06F 3/04815; G06F 3/011; G06F 40/186; G06F 40/40; G06T 19/00; G06F 2203/011; G06T 2200/24; G06T 2219/024; G06V 10/82; G06V 40/174; G10L 25/30; G10L 25/63

(57) ABSTRACT

A system includes a processor that is configured to provide a user interface that allows a participant to freely select and combine facial elements to create a new face, analyze data of the created face and input facial features as a prompt to a generative artificial intelligence model in order to generate similar faces, generate an urban legend based on facial features when a number of generated faces reaches or exceeds a predetermined threshold, recognize an emotion of the participant and adjust content of the generated urban legend based on the recognized emotion, and present the generated urban legend to the participant in a virtual reality space.

### CROSS-REFERENCE TO RELATED APPLICATION

This application is based on and claims priority under 35 USC 119 from Japanese Patent Application No. 2025-045184 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content generation systems and virtual reality presentation systems are not capable of dynamically generating narrative content that reflects both collective visual patterns created by multiple participants and individual emotional states of a particular participant. Existing generative artificial intelligence systems may generate images or texts based on prompts, but such systems generally do not (i) allow a participant to freely construct a new face by combining facial elements, (ii) use a large number of generated similar faces as a basis for forming an emergent, myth-like “urban legend,” and (iii) adapt the content of that urban legend in real time according to the participant's recognized emotion and present it in a virtual reality space. As a result, user experiences remain static or generic, and do not fully exploit the potential of interactive, emotionally adaptive storytelling in immersive environments. Therefore, there is a need for a system that can analyze participant-created facial data, generate similar faces using a generative artificial intelligence model, derive an urban legend once a predetermined number of such faces has been generated, modulate the narrative based on the participant's emotional state, and present the resulting, personalized urban legend in a virtual reality space.

### SUMMARY

In order to solve the above-described problems, according to one aspect of the present invention, there is provided a system comprising a processor, wherein the processor is configured to provide a user interface that allows a participant to freely select and combine facial elements to create a new face, to analyze data of the created face and input facial features as a prompt to a generative artificial intelligence model in order to generate similar faces, and to generate an urban legend based on facial features when a number of generated faces reaches or exceeds a predetermined threshold. The processor is further configured to recognize an emotion of the participant and to adjust content of the generated urban legend based on the recognized emotion. The processor is also configured to present the generated urban legend to the participant in a virtual reality space. In some implementations, the processor is configured to use features of the generated faces and emotion data of the participant as a prompt to generate the urban legend, and to transmit data to a virtual reality device in order to present the generated urban legend to the participant in the virtual reality space.

The term “system” refers to an arrangement of hardware and software components, including at least one processor and associated memory and interfaces, configured to execute the functions described in the claims.

The term “processor” refers to one or more hardware processing units, such as a central processing unit (CPU), graphics processing unit (GPU), application-specific integrated circuit (ASIC), or programmable logic device, capable of executing instructions to perform the processing operations described in the claims.

The term “participant” refers to a human user who interacts with the system, including through the user interface and the virtual reality space, and whose inputs, actions, and emotional states may be used by the system.

The term “user interface” refers to a graphical, textual, auditory, or mixed-mode interface presented to the participant, through which the participant can select and combine facial elements, view generated faces, and interact with the system.

The term “facial elements” refers to discrete visual components that constitute parts of a face, including but not limited to eyes, noses, mouths, eyebrows, hair, and other facial features that can be selected and combined to form a new face.

The term “new face” refers to a composite facial image or representation created by combining multiple selected facial elements using the user interface provided by the system.

The term “data of the created face” refers to information representing the new face, including identifiers of selected facial elements, parameters indicating positions, sizes, or colors of the elements, and any derived feature data used for analysis and generation.

The term “facial features” refers to numerical or symbolic representations derived from the data of the created face, which characterize aspects of the face, such as shape, proportion, configuration, or style of the facial elements, and which are used as input to a generative artificial intelligence model.

The term “generative artificial intelligence model” refers to a machine learning model, such as a neural network, trained to generate new data samples, including at least facial images or representations, in response to input prompts or conditions.

The term “prompt” refers to data or information, including at least the facial features or emotion data, supplied to the generative artificial intelligence model as input that conditions or guides the output generated by the model.

The term “similar faces” refers to faces generated by the generative artificial intelligence model that share one or more visual, structural, or feature-based similarities with the created face or with previously generated faces.

The term “predetermined threshold” refers to a predefined numerical condition, such as a specified number of generated faces, which, when reached or exceeded, triggers generation of an urban legend by the system.

The term “urban legend” refers to narrative content, including at least a story or description of a fictional or semi-fictional event, phenomenon, or character, which is generated by the system based on facial features and optionally emotion data, and which is intended to resemble a rumor or myth shared among people.

The term “emotion of the participant” refers to an estimated or detected emotional state of the participant, such as fear, curiosity, excitement, or calmness, derived by the system using input signals including but not limited to facial expressions, voice, physiological signals, or interaction patterns.

The term “emotion data” refers to data representing the emotion of the participant, including classification labels, intensity values, or other parameters describing the recognized emotional state, which can be used as part of a prompt for generating or adjusting the urban legend.

The term “adjust content of the generated urban legend” refers to modifying one or more aspects of the narrative, such as tone, style, length, perspective, or plot elements, in response to the recognized emotion of the participant.

The term “virtual reality space” refers to an immersive, computer-generated three-dimensional or pseudo-three-dimensional environment that can be perceived by the participant, typically via a VR device, and within which the generated urban legend can be presented.

The term “virtual reality device” refers to hardware used to present the virtual reality space to the participant, including but not limited to head-mounted displays, VR goggles, motion controllers, positional trackers, and associated audio output devices.

The term “transmit data to a virtual reality device” refers to sending, from the system to the VR device, information necessary to render or present the generated urban legend in the virtual reality space, including at least narrative text, audiovisual assets, scene configuration data, or interaction cues.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

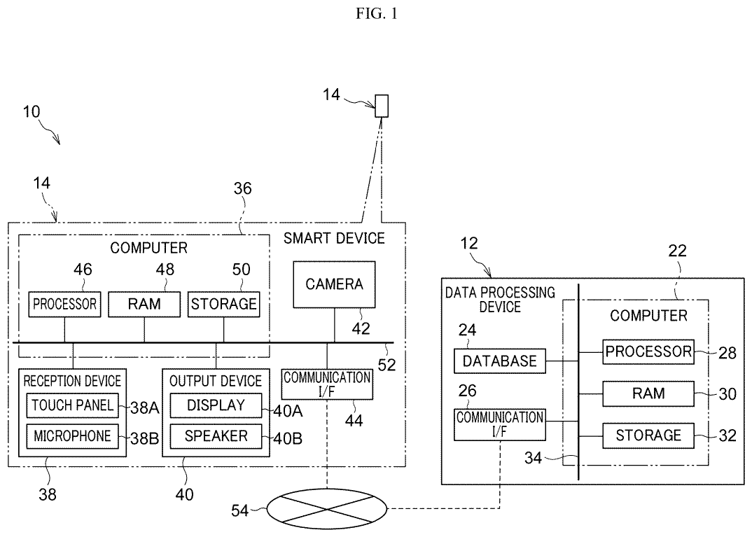

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

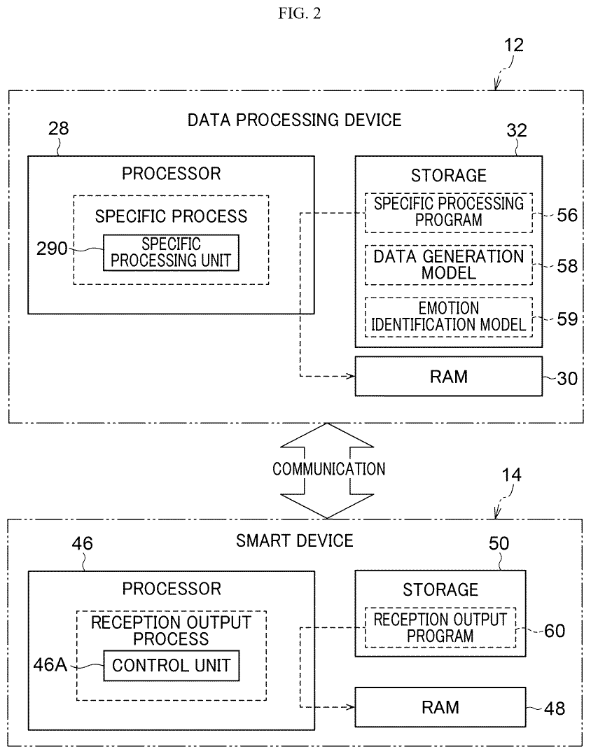

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional face generation and storytelling systems largely operate as isolated pipelines in which user-created face data is merely stored or used once for simple image synthesis, without being exploited as a rich source of structured information for subsequent story generation. In such systems, facial attributes selected by the user are typically handled as static configuration parameters rather than being transformed into machine-interpretable feature vectors that can condition both a generative image model and a narrative generation model. As a result, these systems provide limited personalization, weak semantic linkage between generated faces and narrative content, and no systematic way to use accumulated face data to drive more complex, multi-character stories.

Furthermore, in many existing architectures, human emotional states are either ignored or treated as simple triggers for branching scripts, rather than being integrated as feature information that modulates the behavior of a generative artificial intelligence model. This leads to a mismatch between a participant's emotional context and the generated content, reducing engagement and making it difficult to deliver adaptive, emotionally responsive narratives. In addition, these systems generally do not aggregate facial feature information over multiple generated faces, do not synthesize that information into structured prompt sentences, and do not use those prompt sentences to coordinate image generation and text generation in a unified computational framework.

Moreover, conventional virtual reality content pipelines are often designed around pre-authored media assets, requiring manual authoring of three-dimensional scenes and scripted stories. When generative models are used, they are typically integrated in an ad hoc manner, for example only to generate background images or static characters, without tightly coupling the generative AI model's output to the underlying structured feature data that represents user-created faces and emotional states. This fragmented architecture leads to inefficiencies in data processing, limits reuse of generated features, complicates scaling to multi-character narratives, and imposes constraints on the dynamic adaptation of virtual reality experiences. Accordingly, there is a need for an improved computer-implemented system and method that: (i) encodes user-selected facial components as numerical feature data; (ii) uses such numerical feature data as conditioning information for a generative AI model to create multiple similar facial images; (iii) aggregates the numerical feature data of multiple generated faces and constructs a structured prompt sentence; (iv) inputs the prompt sentence to a text generation artificial intelligence model to generate story content that is semantically tied to the generated faces; (v) incorporates emotion information of the participant as additional feature information that modulates the prompt sentence and the resulting story content; and (vi) delivers the generated story content and facial images to a virtual reality environment in a coordinated manner. By addressing these issues, the invention aims to improve computer technology in the field of interactive content generation by providing a technically integrated pipeline that tightly couples feature encoding, generative image modeling, prompt construction, narrative generation, and virtual reality presentation.

The specific processing by the specific processing unit 290 of the data processing device 12 in Example 1 is realized by the following means.

The present invention provides a server comprising a processor and a storage device, the processor being configured to control a terminal device to provide a user interface that allows a participant to select facial components and combine the facial components to generate facial configuration information; to receive, at an information processing apparatus, structured data representing the facial configuration information from the terminal device, to encode the structured data as numerical facial feature data, and to store the numerical facial feature data as feature vectors in the storage device; to input the numerical facial feature data as conditioning information together with random information into a generative artificial intelligence model executed on computation hardware, to generate a plurality of facial image data items similar to the numerical facial feature data, and to repeatedly store the plurality of facial image data items and corresponding numerical facial feature data in the storage device; to determine whether a number of the facial image data items stored in the storage device is greater than or equal to a predetermined number and, when the number is greater than or equal to the predetermined number, to aggregate the corresponding numerical facial feature data to generate feature description text and to generate a prompt sentence including the feature description text; to input the prompt sentence as input information to a text generation artificial intelligence model and execute the text generation artificial intelligence model to generate story content based on the plurality of numerical facial feature data; to acquire emotion information indicating an emotional state of the participant and adjust contents of at least one of the prompt sentence and the story content based on the emotion information to generate adjusted story content as presentation data; and to transmit the presentation data to a virtual space display device so that the virtual space display device displays the adjusted story content and the plurality of facial image data items in a virtual reality space. This enables an integrated computer-implemented pipeline in which user-selected facial components are transformed into reusable numerical feature vectors that condition both image generation and text generation, in which accumulated facial features and participant emotion information are synthesized into structured prompt sentences driving a text generation artificial intelligence model, and in which the resulting story content and generated facial images are dynamically adapted and coherently presented within a virtual reality environment, thereby improving the efficiency, adaptability, and technical functionality of interactive generative content systems.

The term “processor” refers to one or more hardware-based computation units, such as a central processing unit, a graphics processing unit, or a combination thereof, that execute instructions to perform data processing operations described in the system.

The term “storage device” refers to one or more non-transitory computer-readable media, such as semiconductor memory, magnetic storage, or optical storage, configured to store data, feature vectors, image data, and program instructions used by the processor.

The term “terminal device” refers to a computing apparatus having a display and input interface, such as a personal computer, a tablet device, or a handheld communication device, operated by a participant to interact with the system.

The term “user interface” refers to a software-controlled presentation and input layer displayed on the terminal device that allows the participant to view information and provide selections or commands, including graphical controls for selecting facial components.

The term “participant” refers to a user who operates the terminal device, selects facial components, views generated content, and interacts with the system.

The term “facial components” refers to selectable elements that define portions of a face, such as eyes, nose, mouth, or other facial parts, that can be combined to construct a facial configuration.

The term “facial configuration information” refers to data representing a combination of facial components selected by the participant, including attribute values or identifiers for respective facial components.

The term “structured data” refers to data formatted in a predefined digital structure, such as key-value pairs, records, or hierarchical formats, enabling systematic parsing and processing by the processor.

The term “information processing apparatus” refers to a computing system, which may be implemented by a server or a group of servers, configured to receive, encode, store, and process data related to facial configurations, feature vectors, and generated content.

The term “numerical facial feature data” refers to quantitative data representing characteristics of a face, derived by encoding facial configuration information into numerical values suitable for computational processing.

The term “feature vectors” refers to ordered collections of numerical facial feature data, represented as mathematical vectors, used as input to machine learning models and stored in the storage device.

The term “conditioning information” refers to data, including numerical facial feature data, that is provided as an input condition to a generative artificial intelligence model to control or influence the characteristics of generated outputs.

The term “random information” refers to data, such as a random or pseudo-random vector, that introduces variability into the input of a generative artificial intelligence model to produce diverse generated outputs.

The term “generative artificial intelligence model” refers to a computer-implemented model, such as a neural network-based generative model, configured to generate new data, including image data, based on input data such as feature vectors and random information.

The term “computation hardware” refers to physical processing resources, including processors, accelerators, and associated components, used to execute models, algorithms, and other instructions within the system.

The term “facial image data” refers to digital image information representing one or more faces, including pixel values or encoded image files generated by the generative artificial intelligence model.

The term “predetermined number” refers to a threshold value, defined in advance, that specifies a required quantity of stored facial image data items or related data in order to trigger subsequent processing steps such as prompt generation or story generation.

The term “feature description text” refers to human-readable textual information generated by the processor that describes characteristics represented by numerical facial feature data, such as descriptions of facial attributes.

The term “prompt sentence” refers to a textual input sequence constructed from feature description text and optionally other contextual information, which is provided as input information to a text generation artificial intelligence model to guide the generation of story content.

The term “text generation artificial intelligence model” refers to a computer-implemented model, such as a language model, configured to generate natural language text, including stories, based on input data such as a prompt sentence.

The term “story content” refers to text data representing a narrative, scenario, or description generated by the text generation artificial intelligence model in response to a prompt sentence.

The term “emotion information” refers to data indicating an emotional state of the participant, such as happiness, fear, surprise, or other affective states, obtained through sensors, input devices, or analysis of participant behavior.

The term “presentation data” refers to data prepared for output to a display device, including adjusted story content, facial image data, and associated control information necessary for rendering.

The term “virtual space display device” refers to a display apparatus configured to present a virtual environment, including devices capable of rendering three-dimensional or immersive scenes to a viewer.

The term “virtual reality space” refers to a computer-generated, three-dimensional or immersive environment experienced by the participant through a virtual space display device.

The term “virtual space display data” refers to data including story content, facial image data, and layout or control information formatted for presentation within a virtual reality space.

The term “virtual reality display apparatus” refers to a device or system capable of displaying virtual reality content to a participant, including devices such as head-mounted display apparatuses and three-dimensional image display apparatuses.

The term “three-dimensional image display apparatus” refers to a display system that presents images with depth perception to a viewer, enabling the viewer to perceive a three-dimensional scene.

The term “head-mounted display apparatus” refers to a wearable display device configured to be mounted on the head of a participant, providing immersive visual presentation of virtual reality content.

In one embodiment, a server cooperates with one or more terminals to implement the claimed system. The server includes at least one processor, a main memory, a non-transitory storage device, and a network interface. The terminal includes a display unit, an input unit, a local processor, and a communication interface. The user operates the terminal to access a web-based application provided by the server.

The terminal executes a web browser or a dedicated application implemented using a markup language, a style description language, and a script language. The terminal displays a user interface including selectable facial components such as eyes, nose, mouth, and other facial parts. The terminal renders a composite preview of a face by combining selected components using a two-dimensional drawing interface or a three-dimensional graphics interface. The terminal maintains internal data structures, such as key-value mappings of component identifiers and parameter values, representing a facial configuration.

The terminal transmits the facial configuration information to the server in a structured format over a network. The terminal uses a standardized application protocol to send a message that includes identifiers of the selected facial components and continuous or categorical parameter values associated with those components. The server receives the structured data at the network interface and stores the raw facial configuration information in the storage device as records.

The server converts the received facial configuration information into numerical facial feature data. The server maps symbolic attributes such as “round eyes,” “high nose,” or “small mouth” to numerical encodings such as integer indices, one-hot vectors, or normalized real-valued parameters. The server uses, for example, a pre-defined feature dictionary and a feature encoding module implemented using a numerical computation library. The server aggregates encoded attributes into feature vectors, which are multi-dimensional arrays stored in the storage device as feature vector records associated with the corresponding user and session identifiers.

The server executes a generative AI model using the feature vectors as conditioning information. The server implements the generative AI model as a neural network such as a generative adversarial network or a conditional generative model, built on a machine learning framework such as a tensor computation library. The server loads network parameters into a computation unit such as a graphics processing unit configured with an acceleration library. The server provides, as input to the generative AI model, both the numerical facial feature data and random information such as pseudo-random latent vectors sampled from a predefined probability distribution. The generative AI model includes multiple layers such as convolutional layers, normalization layers, non-linear activation layers, and upsampling layers, which transform the concatenated conditioning information and random information into facial image data.

The server generates a plurality of facial image data items by repeatedly executing the generative AI model with different random inputs while holding the conditioning feature vector fixed or varied within a defined range. The server converts the output tensors of the generative AI model into digital images by scaling numeric values into a pixel range and encoding the arrays into image files. The server stores file references or binary image objects in the storage device together with corresponding feature vectors. The server thereby constructs a growing set of generated faces linked to the underlying numerical facial feature data.

The server manages the accumulation of generated facial image data by maintaining counters or indices in the storage device. The server tracks how many facial image data items are associated with a particular user, session, or feature cluster. When the server detects that a number of stored facial image data items reaches or exceeds a predetermined threshold, the server triggers a prompt sentence generation process. The server retrieves the numerical facial feature data associated with the set of generated faces. The server performs aggregation operations, such as averaging continuous features, determining dominant categorical attributes, or clustering feature vectors, using numerical analysis libraries.

The server converts the aggregated numerical facial feature data into feature description text. The server maps specific value ranges or categorical combinations to natural language descriptors following a rule set or a mapping table stored in the storage device. For example, when an eye-shape parameter exceeds a threshold, the server maps it to “round eyes”; when a nose-height parameter is above a defined level, the server maps it to “high nose”; and when a mouth-size parameter is below another threshold, the server maps it to “small mouth.” The server composes sentences describing one or more characters based on these mappings.

The server generates a prompt sentence by combining the feature description text with contextual instructions suitable for driving a text generation artificial intelligence model. The server constructs a natural language sequence that specifies, for example, the number of characters, shared traits, and desired style of the story. An example of a prompt sentence is: “This face has round eyes, a high nose, and a small mouth. Several similar faces share these same features. Using these facial characteristics, create a mysterious story in which these characters discover a hidden world beneath their town.”

The server uses this prompt sentence as input to a text generation artificial intelligence model. The server implements the text generation model as a neural network based on an attention mechanism, such as a transformer-type architecture, trained on large-scale text corpora. The server supplies the prompt sentence to the model through an application programming interface, and the model produces a sequence of tokens representing story content. The server decodes the token sequence into natural language text and stores the resulting story content in the storage device, linked to the underlying feature vectors and generated faces.

The server acquires emotion information indicating an emotional state of the user. The terminal may capture emotion-related data through input devices such as cameras, microphones, biometric sensors, or explicit user input. The server or the terminal may process raw sensor data using an emotion recognition module, which may include feature extraction and classification stages implemented by a separate neural network or statistical method. The server receives the resulting emotion labels or continuous emotion scores as emotion information.

The server adjusts contents of at least one of the prompt sentence and the story content based on the emotion information. The server modifies certain textual phrases, requested story tone, or intensity descriptors in the prompt sentence in accordance with the detected emotional state. For example, when the user emotion information indicates anxiety or fear, the server may reduce the requested level of suspense in the prompt sentence and emphasize comforting or hopeful aspects. When the emotion information indicates excitement, the server may increase action elements and complexity. The server can also post-process generated story content by replacing or augmenting certain portions according to predefined rules or additional calls to the text generation model with adjusted auxiliary prompts.

The server generates adjusted story content as presentation data and packages it together with references to the plurality of facial image data items. The server formats the presentation data into a representation suitable for a virtual space display device, including timelines, scene metadata, and links between story segments and corresponding character images. The server transmits the presentation data to a virtual space display device, which may include a three-dimensional image display apparatus or a head-mounted display apparatus. The terminal may also act as the virtual space display device when equipped with appropriate rendering capabilities.

The terminal receives the presentation data and renders the adjusted story content and facial image data in a virtual reality space. The terminal uses a three-dimensional graphics engine to construct scenes containing character avatars whose visual appearance is partially or entirely based on the generated facial images. The terminal maps the story content to temporal sequences of scenes and dialogues, synchronizing text display, audio output, and character animations. The user views the resulting immersive experience through a head-mounted display or a three-dimensional display.

The server improves computer technology by introducing a specific data representation and processing pipeline that transforms user-selected facial components into reusable numerical feature vectors that condition both image generation and text generation. The server reduces redundancy by storing feature vectors in a structured manner, enabling efficient retrieval and aggregation. The server improves computational efficiency by using the same feature encodings to drive multiple generative processes, reducing the need for repeated high-dimensional analysis of raw images. By aggregating feature vectors and creating structured prompt sentences, the server constrains the input space of the text generation model, which can reduce generation errors and improve the semantic alignment between generated images and stories.

The server performs non-conventional operations compared to simple human authoring or naïve automation. The server applies a specific combination of numerical encoding, conditional generative modeling, feature aggregation, and prompt construction that is not equivalent to merely digitizing manual tasks. The generative AI model uses conditioning vectors that follow a defined structure, and the text generation model receives prompt sentences that systematically encode multi-character feature relationships and emotion states. This structure enables emergent technical effects such as consistent character appearance across multiple scenes, coherent linkage between visual attributes and narrative roles, and reduced communication bandwidth between the server and terminal because only compact feature vectors and textual prompts, rather than full scene descriptions, need to be transmitted.

The server uses learning-based models trained with explicit loss functions and optimization algorithms to achieve these improvements. During training of the generative AI model, the server or an associated training environment minimizes an objective function such as an adversarial loss combined with a reconstruction loss or a perceptual loss, updating network weights by gradient-based optimization. The server may use data augmentation techniques, such as geometric transformations or color perturbations, to increase robustness of the image generator. During training of the text generation model, the server or a training environment optimizes a sequence prediction objective, such as cross-entropy over token distributions, possibly with additional regularization terms. These trained models, when deployed in the described architecture, provide improved technical performance in terms of generation speed and quality for a given computational budget.

The server implements a modular architecture that separates feature encoding, generative image modeling, feature aggregation, prompt generation, text generation, emotion integration, and virtual reality rendering control into distinct components. Each module exchanges data using clearly defined structures such as feature vector arrays, prompt strings, and scene descriptors. This modular design allows optimized execution paths; for instance, the server can cache feature vectors and aggregated descriptors, avoiding re-computation when generating additional stories or variations. The server can also offload heavy neural network inference to specialized hardware modules, thereby improving throughput and reducing latency in interactive scenarios.

The user benefits from this architecture because the user experiences responsive, coherent stories that are dynamically adapted to the user's facial design choices and emotional state, while the underlying system performs non-trivial computational transformations. The terminal does not simply display static media; instead, the terminal collaborates with the server to render scenes that arise from complex numerical processing. The causal relationship between the structured handling of feature vectors and the technical effects includes reduced error in character consistency, faster regeneration of variations due to cached encodings, and improved data management through centralized, feature-based storage.

In alternative embodiments, the server may employ different generative model architectures, such as a diffusion-based generative model or a variational autoencoder, provided that the model accepts numerical facial feature data as conditioning information. The server may also use different text generation model architectures, such as recurrent neural networks or hybrid models, as long as they generate story content in response to prompt sentences constructed from feature description text and emotion information. The server may change specific encoding schemes, such as using embeddings learned jointly with the generative model instead of fixed mappings, while maintaining the described overall data flow from facial configuration to feature vectors, to generative outputs, to prompt sentences, and then to story content and virtual reality presentation.

In other embodiments, the terminal may be implemented as a wearable device or an augmented reality device, and the virtual space display device may combine virtual content with real-world images. The server may adapt the prompt sentence and story content to include context information about the physical environment detected by sensors, further integrating the generative AI pipeline with real-world conditions. In each case, the server continues to use the defined numerical facial feature data, prompt construction techniques, and emotion-based adjustments to improve the efficiency, precision, and technical functionality of the interactive generative content system.

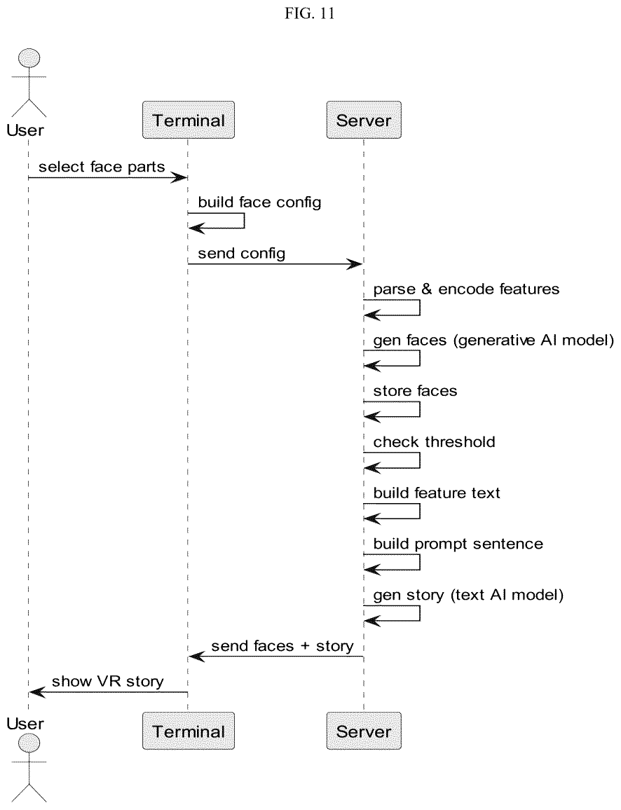

The following describes the processing flow using FIG. 11.

### Step 1:

The user operates the terminal to select facial components.

The user views a graphical user interface on the terminal that displays selectable facial components such as eye types, nose shapes, and mouth sizes. The user manipulates controls including dropdown lists, sliders, and buttons to choose specific component values (for example, “round eyes,” “high nose,” and “small mouth”).

Input: The user provides interaction events such as mouse clicks, touch inputs, or key presses.

Processing: The terminal processes the interaction events using a script engine and updates an internal data structure that stores the selected component identifiers and parameter values. The terminal redraws a preview face image using a two-dimensional canvas or a three-dimensional rendering engine by compositing graphical assets corresponding to the current selections.

Output: The terminal maintains updated facial configuration information representing the user's current selection state and displays a visual preview of the composed face to the user.

### Step 2:

The terminal generates structured facial configuration data.

The terminal converts the current facial configuration information into a structured representation suitable for transmission to the server. The terminal compiles selected component identifiers and their associated parameters (such as size, position, and style) into a structured object.

Input: The terminal uses the internal facial configuration information updated in Step 1.

Processing: The terminal maps each selected component to a symbolic code (for example, an eye-shape code or nose-height level) and organizes these codes into key-value pairs. The terminal then serializes this structure into a standardized format such as a nested attribute list, ensuring that all required keys (eyes, nose, mouth) are present.

Output: The terminal produces structured facial configuration data that encapsulates the user's choices in a machine-readable format.

### Step 3:

The terminal transmits the structured facial configuration data to the server.

The terminal prepares a network request addressed to the server and embeds the structured facial configuration data into the request body. The terminal adds metadata such as user identifiers or session tokens if necessary.

Input: The terminal uses the structured facial configuration data from Step 2 and network configuration data (server address, protocol information).

Processing: The terminal formats an application-layer message and sets appropriate headers to indicate content type and length. The terminal sends the message through a communication interface over a communication network using a reliable transport protocol.

Output: The server receives the structured facial configuration data as part of a network message.

### Step 4:

The server parses and validates the received facial configuration data.

The server accepts the incoming network message and extracts the structured facial configuration data. The server checks the completeness and correctness of the data before further processing.

Input: The server receives the structured facial configuration data from the terminal through the network interface.

Processing: The server parses the message body, converts the structured data into an internal representation such as records or objects, and verifies that required fields are present and within expected value ranges. The server performs error checking, such as detecting unknown component codes or invalid parameter values, and logs request metadata for monitoring.

Output: The server produces validated facial configuration information and stores it temporarily in working memory or persistently in the storage device.

### Step 5:

The server encodes the facial configuration information as numerical facial feature data.

The server converts symbolic facial component codes into numerical values that form machine-interpretable feature vectors.

Input: The server uses the validated facial configuration information from Step 4.

Processing: The server applies a feature encoding scheme that maps each symbolic attribute (such as eye shape category or nose height level) to numeric codes. The server may use one-hot encoding for categorical attributes and normalized real numbers for continuous parameters. The server concatenates these numeric values into an ordered vector and optionally applies scaling or normalization to match the training conditions of the generative AI model.

Output: The server generates numerical facial feature data expressed as feature vectors and stores these feature vectors in the storage device in association with user or session identifiers.

### Step 6:

The server prepares conditioning input for the generative AI model.

The server builds input tensors for the generative AI model using the numerical facial feature data combined with random information.

Input: The server uses the feature vectors produced in Step 5 and a random seed or random number stream.

Processing: The server generates random latent vectors by sampling from a distribution such as a normal distribution or a uniform distribution. The server concatenates each feature vector with a corresponding random latent vector to form a composite input tensor. The server reshapes and formats the input tensor according to the generative AI model's required input dimension and data type.

Output: The server obtains model input tensors that incorporate both conditioning information and random information for use by the generative AI model.

### Step 7:

The server generates similar facial images using the generative AI model.

The server runs the generative AI model on computation hardware to synthesize facial image data conditioned on the feature vectors.

Input: The server uses the model input tensors from Step 6 and a trained generative AI model stored in the storage device or memory.

Processing: The server loads model parameters and executes a forward pass through multiple neural network layers, including, for example, convolutional, normalization, and activation layers. These layers transform the input tensors into output tensors that represent pixel intensities of generated faces. The server may repeat this process multiple times with different random latent vectors for the same feature vector to obtain variations of similar faces.

Output: The server produces one or more facial image data items in tensor format representing faces that are similar to the original facial configuration.

### Step 8:

The server converts generated tensors into image data and stores them.

The server processes the raw output tensors of the generative AI model into standard digital image formats and persistently stores them.

Input: The server uses the facial image tensors from Step 7 and associated feature vectors.

Processing: The server scales numeric tensor values to standard pixel ranges, transforms tensor shapes into image height-width-channel formats, and applies encoding algorithms to convert the processed arrays into compressed image data. The server assigns identifiers or file paths to each generated image and writes the image data and identifiers to the storage device. The server links each stored image record to the corresponding numerical facial feature data and user or session metadata.

Output: The server maintains persisted facial image data and corresponding feature vectors in the storage device.

### Step 9:

The server checks whether a threshold number of generated facial images has been reached.

The server determines if enough facial images are available to trigger story generation.

Input: The server uses stored facial image records and their indexing information from the storage device.

Processing: The server issues queries to count how many facial image data items are associated with a given user, session, or configuration. The server compares the count to a predetermined threshold. If the count is below the threshold, the server may return a status indicating that additional images need to be generated and may return to Step 6 or Step 7 with new random information. If the count meets or exceeds the threshold, the server proceeds to aggregate feature data.

Output: The server outputs a decision result indicating whether the threshold has been reached and, when reached, a list of feature vectors corresponding to the accumulated facial images.

### Step 10:

The server aggregates facial feature vectors and generates feature description text.

The server combines multiple numerical feature vectors into a compact representation and converts this representation into textual descriptions of facial characteristics.

Input: The server uses a collection of numerical facial feature vectors selected in Step 9.

Processing: The server performs aggregation operations such as averaging continuous attributes, tallying categorical attributes, or performing clustering to identify representative traits. The server then applies a mapping from numeric ranges and categorical statistics to human-readable phrases. For example, the server interprets high aggregate eye-roundness values as “round eyes,” high nose-height values as “high nose,” and low mouth-size values as “small mouth.” The server arranges the resulting phrases into coherent sentences describing one or more characters.

Output: The server produces feature description text that summarizes the key characteristics of the group of generated faces.

### Step 11:

The server constructs a prompt sentence for the text generation model.

The server incorporates the feature description text into a prompt sentence that instructs a text generation artificial intelligence model to generate a story.

Input: The server uses the feature description text from Step 10 and optional contextual parameters such as desired story tone, genre, or length.

Processing: The server combines the descriptive phrases with directive language specifying the type of narrative to be produced. The server structures the text as a coherent natural language sequence that the text generation model can interpret as instructions. For example, the server may construct the following prompt sentence:
“This face has round eyes, a high nose, and a small mouth. Several similar faces share these same features. Using these facial characteristics, create a mysterious story in which these characters discover a hidden world beneath their town.”

Output: The server outputs a finalized prompt sentence to be used as input to the text generation artificial intelligence model.

### Step 12:

The server generates story content using the text generation artificial intelligence model.

The server inputs the prompt sentence into the text generation model and obtains narrative text as output.

Input: The server uses the prompt sentence from Step 11 and a trained text generation model stored in the storage device or accessible through an interface.

Processing: The server encodes the prompt sentence into token representations and feeds these tokens into the text generation model, which may include multiple attention layers and feedforward layers. The model predicts subsequent tokens conditioned on the prompt and internal learned parameters. The server repeatedly obtains token predictions until a stopping condition such as an end-of-sequence token or a maximum length is reached. The server then decodes the tokens back into natural language text.

Output: The server produces story content in text form, which describes a narrative involving characters with the facial features summarized in the prompt sentence.

### Step 13:

The server acquires and integrates emotion information of the user.

The server adjusts the generated story content or prompt sentence based on the user's emotional state.

Input: The server uses emotion information captured by the terminal or an associated sensor system, such as emotion labels or scores, and the story content and prompt sentence generated in prior steps.

Processing: The server analyzes the emotion information to determine a suitable modification strategy, such as changing story intensity, mood, or pacing. The server may, for example, detect that the user is anxious and then reduce elements of fear or suspense by editing certain phrases, or it may detect excitement and enhance action and surprise components. The server may also adjust future prompt sentences by including qualifiers like “comforting,” “uplifting,” or “calm” depending on the emotion.

Output: The server produces adjusted story content and, if necessary, revised prompt sentences that better align with the user's current emotional state.

### Step 14:

The server packages presentation data and sends it to a virtual space display device or the terminal.

The server combines the adjusted story content with the generated facial images and scene control information to form presentation data.

Input: The server uses adjusted story content from Step 13, facial image data from Step 8, and configuration data for the virtual space display device or terminal.

Processing: The server organizes the story text into segments correlated with particular characters or scenes, associates each segment with one or more facial images, and encodes scene layout parameters such as character positions and background selections. The server then formats this combined information into a presentation structure suitable for rendering in a virtual reality space, including timing information and interaction hooks. The server transmits the presentation data to a virtual space display device or to the terminal over the network.

Output: The virtual space display device or the terminal receives presentation data that includes adjusted story content, facial images, and control metadata.

### Step 15:

The terminal or virtual space display device renders the story and facial images for the user.

The terminal or virtual space display device presents the generated content in an immersive or interactive environment for the user to experience.

Input: The terminal or virtual space display device uses the presentation data from Step 14.

Processing: The terminal uses a three-dimensional rendering engine or a scene graph engine to construct visuals that include character avatars incorporating the generated facial images. The terminal synchronizes the display of story text, audio narration if applicable, and character movements based on timestamps and scene descriptors included in the presentation data. The terminal responds to user head movements or input events to adjust viewpoints and interactions within the virtual reality space.

Output: The user perceives a virtual reality or interactive display in which the story content and generated faces are coherently presented, reflecting both the original facial selections and the user's emotional context.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative AI models often treat user input as a one-time, static condition and merely output a single item of media, such as an image or a short text, in response to that input. Such systems typically fail to (i) aggregate a large volume of AI-generated assets derived from multiple users over time, (ii) compute higher-order patterns from those aggregated assets, and (iii) feed those patterns back into a narrative generation pipeline in a systematic, machine-controlled manner. As a result, existing systems do not fully exploit the computational capabilities of generative AI models to construct dynamic, data-driven story worlds, and instead behave as isolated “prompt in/content out” tools.

Furthermore, many known systems separate visual generation and narrative generation, so that visual data (e.g., faces) produced by a generative AI model is not programmatically converted into structured feature data and then used as a machine-interpretable input for a story-generation model. This separation prevents the computing system from performing meaningful data processing operations across modalities, such as clustering face feature vectors, deriving group characteristics, and encoding those characteristics into prompt sentences that condition a natural-language generative model. Consequently, the computer functions mainly as a passive conduit between human prompts and AI outputs, rather than as an active processor that transforms and recombines data to generate richer narratives. In addition, conventional systems do not adequately integrate real-time emotional feedback of users into the computational pipeline in a technically robust manner. While some systems may adjust presentation style based on user preferences, they generally do not (i) acquire emotion-related signals as structured data, (ii) incorporate that data into machine-readable prompt sentences for generative AI models, and (iii) algorithmically modify both visual aggregation logic and narrative content generation on the basis of such signals. This lack of deep integration means that the computing process does not adapt the underlying data transformations or model conditioning to the user's emotional state, leading to static or mismatched experiences.

Moreover, in many virtual-reality environments, three-dimensional spaces are pre-authored and manually scripted, with only superficial parameterization by user data. The virtual space is rarely generated or populated by a pipeline that automatically: (i) collects AI-generated faces, (ii) analyzes and aggregates their features at scale, (iii) generates a story based on computed group characteristics, and (iv) places both the generated faces and the generated story into a virtual three-dimensional space for presentation. This limits the ability of the computer system to perform complex data processing and transformation steps that link user-driven facial design, large-scale AI generation, and immersive narrative presentation in a closed computational loop.

Accordingly, there is a need for a computer-implemented system that improves the operation of computing devices by (i) converting user-defined facial configurations into numerical feature data, (ii) using those features to construct structured prompt sentences for a generative AI model to produce a multiplicity of similar faces, (iii) aggregating the resulting face data and determining when a threshold has been satisfied to trigger story generation, (iv) computing group-level characteristics from the aggregated face feature data and encoding those characteristics into story-generation prompt sentences, (v) integrating emotion state data of the user into those prompt sentences and narrative adjustments, and (vi) automatically generating and presenting, in a virtual three-dimensional space, story data that is algorithmically linked to both the generated faces and the user's emotional state. By implementing these steps, the invention aims to provide a technical improvement in how computers orchestrate and coordinate multi-stage generative AI processing, data aggregation, and immersive presentation.

The specific processing by the specific processing unit 290 of the data processing device 12 in Application Example 1 is realized by the following means.

The present invention provides a server comprising a processor configured to (i) provide, to a client terminal, a graphical user interface through which a user selects and combines facial components so as to generate facial image data, (ii) convert attribute information of the facial image data received from the client terminal into numerical feature data and store the numerical feature data in a storage device, (iii) generate a first prompt sentence that includes a descriptive text representing the facial image data based on the numerical feature data and a specification of a desired generation quantity, and transmit request information including the first prompt sentence to a generation information processing apparatus so as to cause a generative AI model executing on the generation information processing apparatus to generate a plurality of facial data similar to the facial image data, (iv) receive the plurality of facial data from the generation information processing apparatus, store the plurality of facial data in the storage device, aggregate a number of stored facial data, and determine whether the aggregated number satisfies a predetermined threshold condition, (v) when the aggregated number satisfies the predetermined threshold condition, analyze feature data of the plurality of facial data stored in the storage device, compute group-level characteristics based on the analyzed feature data, generate a second prompt sentence for story generation that includes a description of the group-level characteristics, and input the second prompt sentence into a natural-language generative AI model so as to generate story data, (vi) acquire, from one or more sensors or input channels, emotion-related information indicative of an emotional state of the user, and modify at least one of the second prompt sentence and the story data in accordance with the emotional state to generate emotion-adapted story data, and (vii) cause generation of virtual-space presentation data by arranging the plurality of facial data and the emotion-adapted story data in a virtual three-dimensional space and transmit the virtual-space presentation data to a display apparatus so that the virtual three-dimensional space is rendered to the user. This enables a computer system to perform improved multi-stage data processing that transforms user-specified facial configurations into numerical features, coordinates generative AI models via structured prompt sentences, algorithmically aggregates and analyzes large quantities of generated facial data, dynamically conditions narrative generation on both feature-based group characteristics and user emotional state, and automatically constructs and presents a data-driven virtual three-dimensional story environment, thereby enhancing the technical functioning of the underlying computing devices.

The term “terminal” refers to an information processing device, such as a personal computer, a mobile device, or a head-mounted display, that provides a user interface for user input and displays data received from a server.

The term “user” refers to a human operator who interacts with the terminal to select and combine facial components, view generated content, and experience a virtual three-dimensional space.

The term “facial component” refers to an element used to construct a face, including at least one of an eye, a nose, a mouth, an eyebrow, or a similar facial part, which can be selected and combined by the user.

The term “facial image data” refers to digital data representing a face generated by combining a plurality of facial components, the data including at least one of image data, vector data, and metadata describing facial attributes.

The term “attribute information” refers to information indicating properties of facial image data, including at least one of a type of facial component, a size parameter, a shape parameter, a color parameter, and a positional parameter.

The term “numerical information” refers to data in a numerical format obtained by converting attribute information, including at least one of scalar values, vectors, or matrices suitable for computational processing.

The term “feature data” refers to numerical information representing characteristics of facial image data, including at least one of feature vectors, latent representations, or descriptors used for analysis, clustering, or generation.

The term “descriptive text” refers to natural-language text that describes facial image data or feature data in human-readable form, including expressions such as “large eyes” or “small nose.”

The term “prompt sentence” refers to a natural-language instruction or query provided as input to a generative AI model, the instruction including at least one of descriptive text, a generation condition, and a parameter specifying a generation quantity.

The term “generation quantity” refers to an instruction indicating the number of data items, such as a number of facial data instances, requested to be generated by a generative AI model.

The term “generation information processing apparatus” refers to an information processing apparatus, including one or more processors and memories, that executes a generative AI model in response to request information including a prompt sentence.

The term “generative AI model” refers to a machine-learned model configured to generate new data, including at least images or feature data, based on input data such as a prompt sentence or feature vectors.

The term “facial data” refers to data generated by a generative AI model that represents one or more faces, including at least one of image data, feature vectors, and latent codes associated with facial characteristics.

The term “storage device” refers to a hardware component or subsystem, such as a memory or a persistent storage unit, configured to store data including facial image data, feature data, facial data, prompt sentences, and story data.

The term “aggregated number” refers to a count value obtained by aggregating a number of facial data items stored in the storage device over time or within a defined group.

The term “predetermined threshold” refers to a reference value set in advance for the aggregated number, used to determine whether a condition for triggering a subsequent process, such as story generation, has been met.

The term “group-level characteristics” refers to characteristics computed from feature data of a plurality of facial data items, including at least one of statistical tendencies, clusters, or common attribute patterns among the plurality of items.

The term “story-generation prompt sentence” refers to a prompt sentence provided to a natural-language generative AI model, the prompt sentence including at least one description of group-level characteristics derived from facial data.

The term “natural-language generative AI model” refers to a machine-learned model configured to generate natural-language text, such as story data, in response to input including prompt sentences.

The term “story data” refers to text data representing a narrative generated by a natural-language generative AI model, including at least one of a sequence of sentences, paragraphs, or sections forming a story.

The term “emotion-related information” refers to information indicative of an emotional state of the user, including at least one of sensor outputs, physiological signals, behavioral signals, and explicit user inputs.

The term “emotional state” refers to a condition of the user's feelings, such as happiness, sadness, fear, surprise, or calmness, inferred or detected from emotion-related information.

The term “emotion-adapted story data” refers to story data that has been generated or modified in accordance with the emotional state of the user, so that content or style of the story is adjusted to the emotional state.

The term “virtual three-dimensional space” refers to a computer-generated environment having three-dimensional coordinates, in which digital objects, including facial data and story elements, are arranged and rendered for presentation.

The term “virtual-space presentation data” refers to data used to render a virtual three-dimensional space on a display apparatus, including at least one of geometry data, texture data, position data, and story-related display elements.

The term “display apparatus” refers to an output device configured to visually present information to the user, including at least one of a flat-panel display, a projection display, and a head-mounted display device.

The term “head-mounted display device” refers to a wearable display apparatus worn on the head of the user, configured to display a virtual three-dimensional space in a field of view of the user.

The term “client terminal” refers to a terminal operated by the user that communicates with the server, providing user input and receiving output including facial image data, facial data, and story data.

The term “server” refers to an information processing apparatus including at least one processor and at least one storage device, configured to execute the processing steps of providing user interfaces, generating prompt sentences, controlling generative AI models, aggregating data, generating story data, and outputting virtual-space presentation data.

In one embodiment, a server cooperates with one or more terminals to implement the claimed system. The server comprises at least one processor, at least one volatile memory, at least one non-volatile storage device, and one or more communication interfaces. The terminal comprises a processor, a display apparatus, an input apparatus such as a touch panel or controller, and a communication interface. The user operates the terminal to define facial configurations and to consume generated content, while the server executes data processing operations including feature extraction, prompt sentence generation, generative AI model control, aggregation computation, story generation, and virtual space construction.

The terminal executes an application implemented, for example, using a cross-platform framework or a native mobile framework. The terminal presents a graphical user interface that displays a library of facial components such as eyes, noses, mouths, eyebrows, and facial outlines. The user selects and combines these facial components to design a face. The terminal stores, in local memory, identifiers of the selected facial components and simple attribute values such as size, rotation, and color. The terminal transmits this attribute information to the server by using a structured data format over a network protocol such as HTTPS.

The server receives the attribute information and converts the information into a numerical representation suitable for machine processing. The server refers to a mapping table stored in the storage device to convert categorical labels of facial components into numerical indices and to map qualitative attributes (for example, “large eyes” or “small nose”) into continuous scalar values. The server generates a feature vector for each facial image by concatenating multiple numerical sub-vectors, such as an eye sub-vector, a nose sub-vector, and a mouth sub-vector. The server uses a numerical library, such as a linear algebra library, to normalize each dimension of the feature vector to a predetermined range, for example [0,1], and stores the normalized feature vectors in a database.

The server generates a descriptive text for each feature vector. The server converts thresholded ranges of the feature values into textual descriptors. For example, when an eye-size dimension exceeds a threshold, the server maps this condition to the phrase “large eyes,” and when a nose-size dimension falls below a threshold, the server maps this condition to the phrase “small nose.” The server combines such phrases according to templates to generate concise descriptions of each face. The server then constructs a first prompt sentence for a generative AI model by embedding the descriptive text in a natural language instruction together with parameters specifying a generation quantity and optional style constraints.

In one example, the server generates a prompt sentence such as:
“Generate 100 faces that are similar to a user-created face with large eyes and a small nose. Each generated face should keep large eyes and a small nose while varying other attributes such as hairstyle and expression.”

The server transmits the prompt sentence and associated parameters to a generation information processing apparatus that executes a generative AI model. The server uses an application programming interface to encode the prompt sentence and numerical parameters into a request message, and the communication interface sends the message to the generation information processing apparatus. The generation information processing apparatus may be implemented as a separate hardware system including one or more graphics processing units. The server identifies the specific generative AI model to be used by including a model identifier in the request.

In one embodiment, the generative AI model is implemented as a neural network based on a diffusion architecture or a generative adversarial network architecture. The generative AI model includes an encoder that converts the prompt sentence into a text embedding vector. The generative AI model further includes a decoder that maps latent vectors, conditioned on the text embedding, into output face representations. The encoder may be implemented as a transformer network that processes tokenized text of the prompt sentence. The decoder may be implemented as a U-Net network in the case of a diffusion model or as a generator network in the case of a generative adversarial network. The generative AI model has been trained in advance by minimizing an objective function, such as a denoising loss function for diffusion or an adversarial loss for a generative adversarial network, using a training dataset of face images and associated textual descriptions.

The server receives the generated face outputs from the generation information processing apparatus. The outputs may include image tensors and internal feature vectors (latent codes). The server may optionally apply a feature extraction model to reduce the dimensionality of the latent codes and to align the feature space with the server's internal feature representation. The server stores the generated facial data, including both image references and feature vectors, in the storage device. The server maintains counters and indices to track how many generated faces exist for each project, each user group, or each set of descriptive conditions.

The server aggregates the generated face data by computing counts and statistical descriptors. The server uses database queries to obtain a current aggregated number of generated faces for a particular scenario. The server compares the aggregated number with a predetermined threshold. When the threshold is not reached, the server simply continues to accumulate generated faces as the user and other users create more facial configurations. When the aggregated number satisfies the threshold condition, the server initiates a story generation phase.

For story generation, the server analyzes the feature data of the aggregated facial data. The server applies clustering algorithms, such as k-means clustering, to group the feature vectors into several clusters that represent distinct character groups. The server calculates cluster centroids and distribution statistics, such as average eye size, nose size variance, or dominant expression features. The server converts these cluster characteristics into natural language fragments. For example, when a cluster centroid corresponds to very large eye size and low brightness values, the server generates a fragment such as “a group of people with very large eyes who prefer the night.” The server combines fragments from multiple clusters into a descriptive summary of the overall population of generated faces.

The server constructs a second prompt sentence for a natural-language generative AI model by embedding the cluster-based descriptions and additional narrative requirements into one or more sentences. The server can also incorporate layout constraints, genre restrictions, and length requirements into the prompt sentence. For example, the server may generate a prompt sentence such as:
“Based on a group of 1000 generated characters who mostly have large eyes and small noses and who gather at night in a secret place, write a fantasy story describing their secret meetings, their customs, and the reason why they look this way. Emphasize the visual traits of large eyes and small noses and describe how these traits influence their society.”

The server provides this prompt sentence to the natural-language generative AI model. The natural-language generative AI model is implemented as a neural network, such as a transformer-based language model that has been pre-trained on large text corpora. The model receives the prompt sentence as input, encodes it into internal contextual embeddings, and generates tokens sequentially by predicting probability distributions over a vocabulary. During training, the model has minimized a cross-entropy loss over token sequences, and during inference, the server can control the decoding strategy by adjusting parameters such as temperature or top-p values. The server supplies these control parameters when sending the prompt sentence.

The server additionally acquires emotion-related information that indicates an emotional state of the user. The terminal may capture explicit user feedback via graphical controls, or a sensor device may capture physiological signals such as heart rate or skin conductance. The server converts the raw signals into a normalized emotion feature vector, using thresholding, filtering, and classification algorithms. For example, the server may use a simple neural classifier or a rule-based mapping from physiological parameters to an emotion label such as “excited,” “anxious,” or “calm.” The server then integrates the emotional state into the story generation pipeline by modifying the second prompt sentence or by performing post-processing on the generated text.

In one example, when the server detects that the user is in a fearful emotional state, the server appends a condition in the prompt sentence such as:
“Adjust the story so that the tone becomes slightly reassuring and hopeful to reduce fear.”

By doing this, the server changes the statistical distribution of the token outputs from the natural-language generative AI model in a controlled manner, leading to story data that better matches the emotional state of the user. The server may further apply rule-based filters to remove content types that are predicted to worsen the detected emotional state.

The server constructs virtual-space presentation data that combines the plurality of generated faces and the generated story. The server defines a virtual three-dimensional coordinate system and assigns spatial positions to instances of the generated faces. The server generates three-dimensional geometry for avatars, attaches face textures derived from the generated facial image data, and associates each avatar with story elements or narrative roles derived from the story data. The server encodes all this information as scene graphs or other structured representations suitable for rendering.

The terminal receives the virtual-space presentation data from the server. When the terminal is a head-mounted display device, the terminal executes a rendering engine that translates the scene graph into stereoscopic images at a high frame rate. The terminal uses head-tracking data to dynamically adjust view matrices and re-render the scene to align with the user's viewpoint. The user thus experiences a virtual three-dimensional space populated with generated characters, where the narrative plays out through visual arrangements, text panels, audio narration, or a combination thereof.

This configuration improves computer technology in multiple ways. The server converts high-level, discrete selections of facial components into continuous feature vectors, which significantly reduces redundancy in data storage and improves retrieval and clustering efficiency. By using normalized vectors and precomputed mappings, the server can perform clustering and similarity searches with reduced computational cost compared to naive image comparisons. The aggregation of generated facial data and the threshold-based triggering of story generation reduces communication overhead by batching expensive generative model calls, instead of triggering them for every user action.

The server's generation of structured prompt sentences from computed feature statistics enables a form of model orchestration that goes beyond simple automation of human tasks. The server systematically converts multi-modal numerical data into natural language conditions in a way that is not intuitive for a human operator to perform reliably and repeatedly. This conversion uses predetermined mapping rules, thresholds, and aggregation logic, so that the resulting prompt sentences consistently encode statistical properties of large facial datasets. Such consistent encoding improves the reproducibility and accuracy of model outputs and enhances the quality of the generated stories.

The server's integration of emotion-related information into the story generation process also yields technical advantages. The server maintains a compact representation of emotional state as a feature vector and uses this representation to alter the weighting of narrative parameters. This can be implemented by mapping emotional dimensions to changes in decoding parameters or to changes in the composition of the prompt sentence. As a result, the natural-language generative AI model can be steered with fine-grained control that would not be achievable by a human operator alone in real time. The system thereby reduces latency in adapting content to the user's state and reduces error in matching the narrative tone to the user's emotional state.

The server's combination of feature-based clustering, prompt construction, and generation of virtual-space presentation data also improves data management. By storing faces as high-dimensional vectors and clustering them, the server can reuse previously generated faces in new story contexts without regenerating them, which reduces the computational load on the generative AI model. The server can also apply indexing structures, such as k-d trees or approximate nearest-neighbor indices, to quickly retrieve faces that match new user-defined conditions.

In another embodiment, the server uses a different type of generative AI model, such as a variational autoencoder, but still follows the same principle of converting feature vectors into prompt sentences and aggregating generated data to compute group-level characteristics. In yet another embodiment, the terminal may be a flat-panel display device rather than a head-mounted display, but the server still constructs a virtual three-dimensional space and transmits camera views to the terminal. In a further embodiment, the emotion-related information may be derived solely from explicit user inputs, such as selecting an emotion from a list, instead of from physiological sensors.

The user benefits from a system that can automatically transform their facial designs into a large, consistent population of characters and integrate those characters into interactive narratives, while the underlying server performs specialized data transformations and model coordination that constitute more than mere automation of a human storytelling process. By tightly coupling numerically defined feature spaces, generated prompt sentences, generative AI model operations, and virtual-space rendering, the system improves the technical functioning of the server and terminal, reducing computation, increasing responsiveness, and enabling real-time adaptation of complex, multi-modal content.

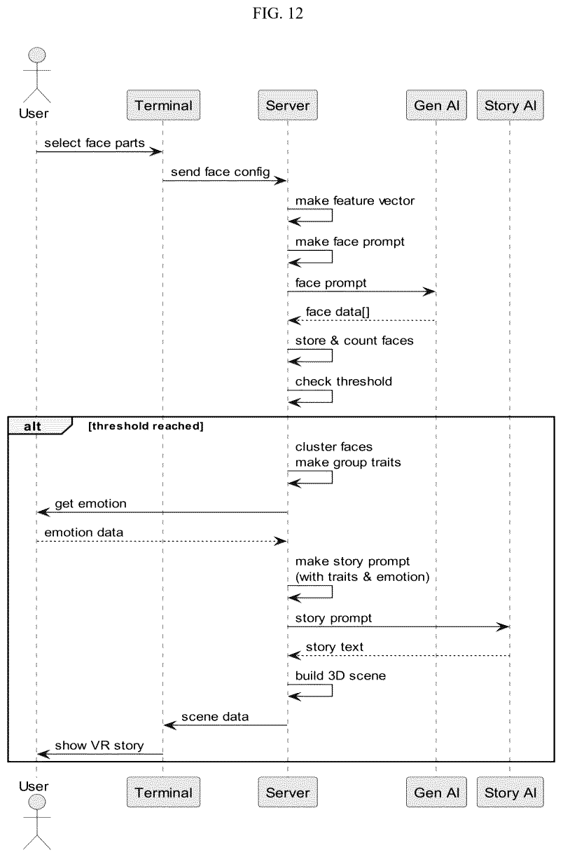

The following describes the processing flow using FIG. 12.

### Step 1:

The terminal displays a face-creation user interface and receives user selections of facial components.

The terminal presents, on a display, selectable icons or controls for eyes, noses, mouths, eyebrows, and other facial components, using a rendering engine implemented for example with a native graphics library.

The user selects one or more types of facial components and adjusts parameters such as size, rotation, and color through touch or controller input.

The terminal combines the selected facial components into a composite facial image and updates a preview in real time.

Input: user input events (component selections, parameter adjustments).

Output: a structured configuration of the face, including component identifiers and attribute values stored in a data structure.

### Step 2:

The terminal encodes the facial configuration and transmits it to the server.

The terminal converts the selected components and attributes into attribute information, for example a key-value representation indicating component types and numeric parameters.

The terminal packages the attribute information with user and session identifiers into a request message.

The terminal sends the request message to the server over a network using a protocol such as HTTPS.

Input: facial configuration data in application-specific structures.

Output: a network request containing serialized attribute information delivered to the server.

### Step 3:

The server receives the attribute information and generates numerical feature data.

The server parses the request message and validates required fields, such as component types and basic parameters.

The server accesses a mapping table stored in a storage device to convert categorical labels into numerical indices and to map qualitative descriptors to continuous values.

The server concatenates these numerical values into a feature vector representing the face and normalizes each dimension into a predetermined range using numerical operations.

Input: attribute information received from the terminal.

Output: normalized numerical feature data (feature vector) for the user-created face stored in server memory.

### Step 4:

The server generates a descriptive text and a first prompt sentence for a generative AI model.

The server compares each element of the feature vector against predefined thresholds and maps the results to textual phrases such as “large eyes,” “small nose,” or “smiling mouth.”

The server combines these phrases into a descriptive text using a template, ensuring grammatical correctness and consistent ordering of features.

The server embeds the descriptive text and a generation quantity into a natural-language instruction, thereby creating a first prompt sentence for face generation.

Input: numerical feature data for the user-created face.

Output: a first prompt sentence that describes the face and specifies how many similar faces should be generated.

### Step 5:

The server transmits the first prompt sentence to a generation information processing apparatus and requests generation of similar faces.

The server constructs a request payload containing the first prompt sentence, a generation quantity, and control parameters such as random seed and diversity settings.

The server sends the payload to the generation information processing apparatus via an application programming interface.

The server awaits a response and monitors timeouts or communication errors, optionally performing retries.

Input: first prompt sentence and associated generation parameters.

Output: a formatted request delivered to the generation information processing apparatus.

### Step 6:

The server on the generation information processing apparatus executes a generative AI model to produce multiple facial data items.

The server on the apparatus encodes the first prompt sentence using a text encoder, converting tokens of the sentence into a text embedding vector.

The server on the apparatus samples latent variables and conditions a generative neural network, such as a diffusion-based network or a generative adversarial network, on the text embedding to generate face representations.

The server on the apparatus post-processes the generated outputs into a standardized format, such as image tensors or latent feature vectors.

Input: first prompt sentence and generation parameters received from the main server.

Output: a plurality of facial data items (images, feature vectors, or latent codes) prepared for return to the main server.

### Step 7:

The server receives and stores the generated facial data.

The server parses the response from the generation information processing apparatus and validates that the expected number of facial data items is present.

The server associates each facial data item with the originating user or project and inserts corresponding records into a database or other storage device.

The server may extract additional feature vectors from image data using a feature extraction model to ensure compatibility with existing feature representations.

Input: plurality of facial data items returned from the generation information processing apparatus.

Output: stored records of generated facial data, each including identifiers, references, and feature vectors.

### Step 8:

The server aggregates the stored facial data and determines whether a threshold condition for story generation is satisfied.

The server executes queries against the storage device to count how many facial data items are associated with a given context, such as a scenario or user group.

The server compares the aggregated count with a predefined threshold value and sets an internal flag indicating whether the threshold is met.

The server logs the aggregated count and threshold result for monitoring and further processing.

Input: stored facial data and aggregation criteria such as project identifiers.

Output: an aggregation result including a numerical count and a Boolean indicator of threshold satisfaction.

### Step 9:

The server analyzes feature data of the aggregated faces and computes group-level characteristics.

The server retrieves feature vectors for the relevant facial data from the storage device.

The server applies a clustering algorithm, such as k-means, to the feature vectors to partition the data into groups representing distinct character types.

The server calculates statistics for each cluster, including averages and variances of key feature dimensions, and interprets these statistics into qualitative characteristics such as “characters with very large eyes who often smile.”

Input: feature vectors of a plurality of facial data items.

Output: group-level characteristics, including cluster assignments and descriptive statistics for each group.

### Step 10:

The server generates a second prompt sentence for a natural-language generative AI model based on the group-level characteristics.

The server converts numerical statistics from each cluster into natural-language fragments that describe typical traits of each character group.

The server combines the fragments into a coherent description of the overall population and specifies narrative requirements such as genre, tone, and length.

The server embeds this description and the narrative requirements into a second prompt sentence that instructs the natural-language generative AI model to generate story data.

Input: group-level characteristics derived from cluster analysis.

Output: a second prompt sentence that encodes the aggregated facial traits and defines the desired narrative.

### Step 11:

The server acquires emotion-related information from the user and adapts the second prompt sentence or story parameters.

The terminal collects emotion inputs from the user, such as explicit selection of an emotion label or signals from attached sensors, and transmits the emotion-related information to the server.

The server normalizes the emotion-related information into an emotion feature vector and classifies the emotional state using predetermined rules or a trained classifier.

The server modifies the second prompt sentence by adding or altering clauses that specify narrative tone or content suitable for the detected emotional state, or stores parameters to adjust decoding behavior of the natural-language generative AI model.

Input: emotion-related information representing the user's current emotional state.

Output: an emotion-adapted second prompt sentence or associated control parameters for story generation.

### Step 12:

The server provides the emotion-adapted second prompt sentence to the natural-language generative AI model and generates story data.

The server constructs a request message including the second prompt sentence and any parameters such as maximum length, temperature, and sampling strategy.

The server sends the request to a language model execution environment and receives a stream or batch of generated tokens representing the story.

The server concatenates the tokens, performs minimal post-processing such as trimming incomplete sentences and normalizing spacing, and stores the resulting story text as story data.

Input: emotion-adapted second prompt sentence and generation control parameters.

Output: story data representing a narrative customized to the group-level characteristics and the user's emotional state.

### Step 13:

The server constructs virtual-space presentation data combining the story data and the plurality of facial data.

The server defines a virtual three-dimensional coordinate space and assigns positions, orientations, and animations to avatars corresponding to selected facial data items.

The server associates segments of the story with specific avatars or regions in the virtual space, for example by linking paragraphs to scene locations.

The server encodes geometry, textures derived from facial images, spatial layouts, and narrative annotations into a scene representation suitable for rendering by a terminal.

Input: stored facial data and generated story data.

Output: virtual-space presentation data describing a virtual three-dimensional environment populated with story-linked characters.

### Step 14:

The terminal receives the virtual-space presentation data and renders the virtual three-dimensional space to the user.

The terminal downloads or receives the presentation data from the server and stores it in local memory.

The terminal executes a rendering engine that interprets the scene representation, generates three-dimensional graphics, and renders frames to the display or head-mounted display.

The terminal updates the viewpoint based on user head or input movements and optionally synchronizes visual events with text or audio narration from the story data.

Input: virtual-space presentation data received from the server.

Output: rendered images and related media presented to the user, enabling interactive consumption of the generated story within the virtual three-dimensional space.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content generation systems that use artificial intelligence to create images or narratives generally accept manually written prompts or simple attribute tags as input. In such systems, a user must translate creative intentions into textual instructions, and a generative AI model then produces an image or a story based on those instructions. This architecture has several technical limitations from the viewpoint of computer technology. First, conventional systems do not automatically transform structured, fine-grained configuration data of user-created visual objects into robust numerical feature vectors that are optimized for interaction with a generative AI model. In particular, when a user interactively designs a composite facial image by selecting and arranging multiple facial components on a graphical interface, the underlying system often treats the resulting data as a static image or as unstructured metadata. As a result, the system does not exploit a unified representation that supports both large-scale similarity-based generation of new facial configurations and downstream narrative generation.

Second, conventional systems do not provide an integrated pipeline in which a computing device automatically: (i) encodes user-created facial configurations as numerical feature vectors; (ii) uses a generative AI model to generate many similar facial feature vectors in a latent space; (iii) aggregates statistical properties of those generated feature vectors; and (iv) converts the aggregated properties into a structured prompt sentence for a text-generating generative AI model. Instead, these steps, if performed at all, are implemented in an ad hoc manner, often requiring manual curation, manual prompt writing, or disjoint processing stages that are not tightly coupled in data format or control flow. This leads to inefficient use of computing resources, inconsistent narrative quality, and difficulty in scaling to large numbers of generated faces.

Third, existing systems for narrative generation typically do not incorporate dynamic emotional feedback from a participant as a structured input for adjusting narrative content at the model level. Emotional reactions may be collected as separate user feedback, but such information is rarely integrated as machine-readable emotion information into the prompt sentence fed to the text-generating generative AI model. Consequently, the generated narratives are not adaptively tuned to the participant's emotional state in real time, and the computing system does not leverage emotion-aware conditioning to control generative behavior of the model.

Fourth, conventional virtual reality presentation pipelines generally render static or preauthored scenes that are only loosely related to AI-generated narratives. There is no unified mechanism in which a processor converts both AI-generated narrative text and face configuration data into display control data for a three-dimensional virtual space, thereby causing a virtual reality display device to present content that is synchronized with the narrative and directly reflects the statistical facial features learned from generative sampling in latent space. This separation between narrative generation and virtual reality rendering leads to low coherence between text and visuals and requires significant manual authoring to align them.

Accordingly, there is a need for a computer-implemented system that improves the technical process of generative content creation by: (i) automatically encoding user-configured facial data as feature vectors suitable for generative AI processing; (ii) generating and storing similar-face feature vectors through latent-space operations of a generative AI model; (iii) computing statistical facial features from large sets of generated vectors; (iv) transforming those statistics into a machine-generated prompt sentence for a text-generating generative AI model; (v) incorporating emotion information from a participant into the prompt sentence to condition the narrative; and (vi) converting the resulting narrative text and facial configuration data into display control data for a virtual reality environment. By implementing this end-to-end, model-centric workflow, the computer system can more efficiently utilize computing resources, provide consistent and coherent narrative and visual content, and improve the functioning of the computer in generating adaptive, feature-aware, and emotion-aware stories in both two-dimensional and three-dimensional presentation environments.

The specific processing by the specific processing unit 290 of the data processing device 12 in Example 2 is realized by the following means.

The present invention provides a server comprising a processor and one or more memory devices storing instructions that, when executed by the processor, cause the processor to provide a graphical user interface that enables a user terminal to display a plurality of facial components on a display screen and allows a participant to select and manipulate at least a position, a size, and a shape of the facial components so as to generate face image configuration information as structured data and to transmit the structured data from the user terminal to the server; to receive, at the server, the face image configuration information, to store the face image configuration information as face image configuration data in a storage device, to associate identifiers of the facial components with predetermined codes, to normalize the position and the size values, and to convert the face image configuration information into numerical feature values so as to generate a feature vector representing the facial configuration; to input the feature vector to a first generative AI model implemented on the server, to perform latent-space processing in the first generative AI model to generate a plurality of latent representations that are close to the feature vector in a latent space, to decode the plurality of latent representations into a plurality of similar-face feature vectors, and to additionally store the similar-face feature vectors as part of the face image configuration data in the storage device; to count a number of similar-face feature vectors stored in the storage device, to determine that the number is equal to or greater than a predetermined threshold, to compute statistical information of facial features based on the plurality of similar-face feature vectors, and to extract representative facial features from the statistical information; to generate, based on the representative facial features and the number of similar-face feature vectors, a prompt sentence that includes a natural language expression describing the representative facial features and condition information for narrative generation, and to input the prompt sentence to a second generative AI model configured to generate narrative text so as to cause the second generative AI model to output the narrative text; to optionally obtain emotion information indicating an emotional state of the participant and to incorporate the emotion information into the prompt sentence such that the narrative text is conditioned on the emotion information; and to convert the narrative text and at least a portion of the face image configuration data into display control data for presentation on a terminal device including, in some embodiments, a virtual reality display device, to transmit the display control data to the terminal device, and to cause the terminal device to render visual information corresponding to the narrative text and the face image configuration data. This enables the computing system to automatically transform user-specified facial configurations into feature-vector representations suitable for latent-space generative processing, to generate large sets of similar faces and derive statistically representative facial characteristics, to construct structured prompt sentences that condition a text-generating generative AI model on both facial features and emotion information, and to produce coherent narrative and visual content that is efficiently rendered on display devices including virtual reality environments, thereby improving the functioning of the computer in generative content creation and adaptive storytelling.

The term “processor” refers to a hardware-based information processing unit, such as a central processing unit or a graphics processing unit, that executes instructions to perform arithmetic, logical, control, and input/output operations required by the system.

The term “memory device” refers to a hardware storage component, such as volatile memory or non-volatile memory, configured to store instructions and data for access by the processor.

The term “storage device” refers to a hardware data store, such as a magnetic disk, a solid-state drive, or a network-attached storage unit, configured to persistently store face image configuration data, feature vectors, and narrative text.

The term “display device” refers to an output apparatus, such as a monitor, a flat panel display, or a head-mounted display, configured to visually present information to a participant.

The term “terminal device” refers to a computing apparatus, such as a personal computer, a tablet device, or a handheld communication device, that communicates with the server and provides a user interface to the participant.

The term “virtual reality display device” refers to a head-mounted or immersive display apparatus configured to present a three-dimensional virtual space to a user, including visual content controlled by display control data.

The term “participant” refers to a human user who interacts with the system through a terminal device by selecting and manipulating facial components and by viewing generated content.

The term “graphical user interface” refers to a visual interaction environment presented on a display device, including graphical elements such as icons, menus, canvases, and controls, through which the participant can input commands and manipulate facial components.

The term “facial components” refers to selectable visual elements that represent parts of a face, including at least eyes, noses, mouths, and optionally other facial parts, that can be combined and arranged to form a facial configuration.

The term “face image configuration information” refers to structured data that specifies a facial configuration created by a participant, including identifiers of selected facial components and associated layout parameters.

The term “face image configuration data” refers to data stored in the storage device that represents one or more facial configurations, including original facial configurations created by participants and similar-face configurations generated by the system.

The term “structured data” refers to data organized according to a defined schema or format, such as a key-value representation or a record structure, enabling systematic parsing, validation, and processing by the system.

The term “position” refers to spatial location information of a facial component within a coordinate system of a display or canvas area, typically expressed as one or more coordinates.

The term “size” refers to dimensional information of a facial component, such as width, height, or scale factors, that determine the spatial extent of the component within the facial configuration.

The term “shape” refers to geometrical or stylistic characteristics of a facial component, including contour, outline, or form attributes that distinguish one component type from another.

The term “predetermined code” refers to a symbolic or numeric identifier assigned in advance to a facial component type, used to encode the component in a manner suitable for computational processing.

The term “numerical feature values” refers to numeric quantities derived from face image configuration information, including encoded component identifiers and normalized layout parameters, that are used as inputs to a generative AI model.

The term “feature vector” refers to an ordered set of numerical feature values representing a facial configuration in a vector space, suitable for processing by machine learning algorithms.

The term “generative AI model” refers to a machine learning model configured to generate new data samples, such as feature vectors or text sequences, based on learned probability distributions or latent representations.

The term “first generative AI model” refers to a generative AI model configured to operate on feature vectors representing facial configurations, to generate latent representations and similar-face feature vectors in a latent space.

The term “second generative AI model” refers to a generative AI model configured to generate narrative text based on an input prompt sentence, such as a text-generating language model.

The term “latent space” refers to a mathematical representation space used by a generative AI model, in which data samples are encoded as latent representations that capture abstract features and relationships among samples.

The term “latent representation” refers to a numerical vector in a latent space that encodes abstract characteristics of a facial configuration or other data, as produced or consumed by a generative AI model.

The term “similar-face feature vector” refers to a feature vector generated from a latent representation that represents a facial configuration determined by the system to be similar to a base facial configuration.

The term “predetermined threshold” refers to a value, such as a numeric count, that is set in advance and used as a condition for triggering specific processing, including narrative generation.

The term “statistical information of facial features” refers to aggregated quantitative data derived from a plurality of feature vectors, such as counts, frequencies, averages, or distributions of component types and layout parameters.

The term “representative facial features” refers to facial characteristics extracted from statistical information, including dominant or typical attributes of facial components and layout patterns among a group of facial configurations.

The term “prompt sentence” refers to a natural language text string that describes at least representative facial features and condition information and is provided as input to a generative AI model to guide generation of narrative text.

The term “condition information” refers to control parameters or constraints included in a prompt sentence, such as desired narrative style, length, tone, or thematic elements, that influence behavior of a generative AI model.

The term “narrative text” refers to a sequence of natural language sentences or paragraphs generated by a generative AI model, forming a story or other textual content.

The term “output data” refers to data generated by the server for transmission to a terminal device, including narrative text, display control data, or other presentation-related information.

The term “emotion information” refers to data indicating an emotional state of a participant, such as happiness, fear, excitement, or sadness, obtained through user input, sensors, or analysis of interaction data.

The term “display control data” refers to data that specifies how narrative text and face image configuration data are to be visually rendered in a display environment, including layout, timing, and spatial position information.

The term “three-dimensional virtual space” refers to a computer-generated spatial environment with three-dimensional coordinates, in which virtual objects and scenes are rendered for presentation to a user.

The term “visual information” refers to image or graphical content rendered on a display device, including two-dimensional images, three-dimensional scenes, and user interface elements corresponding to facial configurations and narrative content.

In an embodiment, a server cooperates with one or more terminal devices operated by a user to implement a system for generating narrative text based on facial configurations. The system is realized by a combination of hardware resources, including at least one server-class computer with a central processing unit (CPU), an optional graphics processing unit (GPU), a main memory, and a persistent storage device such as a solid-state drive, and client hardware including a terminal equipped with a display device, an input device (e.g., touch screen, mouse, or keyboard), and a communication interface. The system further employs software components such as a web browser on the terminal, a web application framework and an application server on the server, and machine learning libraries such as a tensor computation framework (e.g., a general-purpose numerical library) for implementing a generative AI model.

A terminal executes a browser or native application that presents a graphical user interface (GUI) generated by the server. The terminal displays a palette of facial components, such as eyes, noses, mouths, and optionally additional features (e.g., eyebrows, hair shapes), as selectable graphical items. The terminal allows the user to position each facial component on a canvas region, adjust its size and rotation, and choose among predefined shapes and styles. The terminal internally maintains a data structure for the current face, for example, a set of records containing, for each component, a component type identifier, a position in a two-dimensional coordinate system, a scale factor, and a rotation angle. The terminal transmits this information to the server as structured data via a communication network.

The server receives the facial configuration information and stores it as face image configuration data in a structured form in a database management system. The server maps each facial component type identifier to a predetermined code, for example, an integer index in a lookup table, and normalizes the positional and scaling parameters with respect to a canonical canvas size. The server generates numerical feature values by combining these encoded component identifiers and normalized layout parameters into a fixed-length feature vector for each face configuration. In one example, the server concatenates one-hot encoded vectors representing component categories with continuous values representing coordinates and scale factors, yielding a vector in a moderate-dimensional Euclidean space. The server may apply additional pre-processing, such as standardization or principal component analysis, to shape the feature space.

The server inputs the feature vector to a first generative AI model configured to operate on vectors in the feature space. The server may implement the first generative AI model as a neural network-based generative architecture, such as a variational autoencoder (VAE), a generative adversarial network (GAN), or a diffusion model. In one embodiment, the server implements a VAE that comprises an encoder network, which maps input feature vectors to latent representations, and a decoder network, which maps latent representations back to feature vectors. The encoder and decoder may each be formed as a multi-layer neural network with fully connected layers and nonlinear activation functions. During an off-line training phase, the server trains the VAE using a dataset of facial configuration feature vectors stored in the storage device, using a reconstruction loss (e.g., mean squared error between input and reconstructed feature vectors) combined with a regularization term (e.g., Kullback-Leibler divergence between the learned latent distribution and a prior distribution). The server updates model weights by performing gradient-based optimization, such as stochastic gradient descent or an adaptive optimization method, and may use data augmentation in feature space by perturbing positions or scales.

At runtime, the server encodes the feature vector representing the user-created face into a point in the latent space. The server samples a plurality of latent representations in the vicinity of this point by adding random perturbations drawn from a specified distribution (e.g., Gaussian noise scaled by a variance parameter) to the latent representation. The server decodes each latent representation into a new feature vector, which the server interprets as a “similar-face” feature vector. The server then maps each similar-face feature vector back to a discrete facial configuration by choosing, for each categorical dimension, the component code corresponding to the maximum output probability or logit, and by denormalizing continuous dimensions based on the stored normalization parameters. The server stores each resulting similar-face configuration as additional face image configuration data in the database.

The server improves computer performance by structuring feature vectors and latent space operations in a way that supports efficient similarity-based generation. Because the server restricts the facial configuration representation to a compact fixed-length feature vector and uses a trained encoder-decoder architecture, the server can generate large numbers of similar-face configurations with a reduced number of floating-point operations per face compared to directly manipulating high-resolution image data. The use of normalized and encoded facial components also simplifies indexing and retrieval within the database: the server can index component codes and latent cluster identifiers, thereby enabling more efficient querying and aggregation than would be possible with unstructured graphics data.

When the server determines that the number of stored similar-face feature vectors associated with an original face has reached or exceeded a predetermined threshold, the server computes statistical information of facial features across the stored similar-face feature vectors. The server retrieves the relevant feature vectors from the database and performs aggregation operations, such as counting the frequency of each component code, computing averages and variances of positional and scaling parameters, and computing cluster centers in the latent space. The server identifies representative facial features by selecting facial components with high frequency and by computing typical positions and sizes that minimize a defined distance measure (for example, Euclidean distance) between the representative configuration and the collection of feature vectors. This aggregation is carried out in vector space and with respect to structured feature data, which differs from human intuitive judgment and provides a consistent, machine-optimized summary of the generated faces.

The server transforms the representative facial features and the count of similar faces into a prompt sentence for a second generative AI model, which is a text-generating model. The server synthesizes a natural language description of the representative features based on mapping rules from component codes to textual descriptors. For example, if the most common eye component code corresponds to “large round eyes,” the most common nose code to “small high nose,” and the most common mouth code to “thin lips,” the server may produce a phrase such as “large round eyes, small high nose, thin lips.” The server incorporates the number of similar faces and additional narrative condition information, such as genre and tone, into the prompt sentence.

Examples of the prompt sentence include the following:
“Face features: large round eyes, small high nose, thin lips. Number of similar faces: 1000. Please generate a fantasy story about people who share these features and gain special powers at night.”
“Face features: sharp almond-shaped eyes, long straight nose, wide smiling mouth. Number of similar faces: 500. Please generate a science-fiction story where people with these features are explorers of distant galaxies.”
“Face features: droopy eyes, button nose, full lips. Number of similar faces: 1200. Please generate a heart-warming story about a town where all residents share these features.”

The server may further obtain emotion information indicating an emotional state of the user, for example by collecting self-reported data via dialog boxes, by using sensor inputs such as facial expression analysis or voice analysis, or by evaluating user interaction patterns. The server encodes this emotion information into machine-readable form, such as categorical labels or continuous values along affective dimensions (e.g., valence and arousal), and appends corresponding expressions to the prompt sentence, such as “The main characters feel anxious and hopeful at the same time.” In this way, the server conditions the narrative generation on both the facial features and the emotional context.

The server inputs the prompt sentence to the second generative AI model, which may be a neural network-based language model. The server can implement the language model as a transformer architecture, including an embedding layer, a stack of self-attention layers, and a final projection layer. During a training phase, the server or another computing environment trains the language model on large corpora of narrative text, using maximum likelihood estimation to minimize cross-entropy loss between predicted tokens and ground-truth tokens. At inference time, the server encodes the prompt sentence as token embeddings, processes them through the transformer layers, and iteratively generates new tokens based on output probabilities, using sampling strategies such as top-k or nucleus sampling. The server receives the output token sequence and decodes it into narrative text.

Because the server constructs prompt sentences directly from statistically derived facial features and emotion information, the server achieves improved control of the generative behavior of the language model. Unlike manual prompting by a human user, the server consistently encodes complex multidimensional feature statistics into a standardized textual input. This reduces variability in model behavior, improves reproducibility of narrative characteristics for similar facial distributions, and allows the server to implement optimization strategies at the prompt-construction layer to achieve desired narrative properties while minimizing the number of model inference calls.

The server converts the narrative text and the face image configuration data into display control data suitable for the terminal. For a two-dimensional display device, the server may generate layout specifications such as text positions, line breaks, and mapping between narrative segments and facial visuals (e.g., rendering a representative face near the beginning of the story). For a three-dimensional virtual reality display device, the server may further generate spatial coordinates, orientation information, and timing metadata that align scene changes with narrative events. The server transmits this display control data, along with the narrative text and, optionally, representative facial configurations, to the terminal or to a virtual reality headset.

The terminal receives the display control data and renders corresponding content. For example, in a standard monitor environment, the terminal displays the narrative text as paragraphs and draws a face image or multiple faces based on the configuration data. In a virtual reality environment, the terminal (or VR device) constructs a three-dimensional scene by placing virtual avatars or face-like objects at specified locations and synchronizing their appearance with narrative segments. This linkage between high-level narrative structure and low-level display control data improves user immersion and enhances the technical integration between text generation and rendering pipelines.

The system provides several technical advantages and improves the functioning of the computer. Because the server operates on compact feature vectors instead of raw images, the server reduces the computational cost for similarity generation and statistical aggregation, which shortens processing time and lowers memory consumption. The use of an encoder-decoder architecture and latent-space sampling allows the server to generate many similar faces efficiently, which would be computationally more expensive if naive pixel-based transformations were used. The structured aggregation of generated feature vectors and the automatic construction of prompt sentences reduces the need for manual prompt design and avoids repetitive retrieval of large text templates, thereby reducing communication load between client and server for narrative customization.

Furthermore, by encoding the user's emotion information into the prompt sentence as a structured parameter, the server enables fine-grained control of narrative style directly at the model input layer. This is not a simple automation of human editing because the server uses explicit, quantifiable emotion parameters and learned mappings between emotion conditions and textual realizations. The server can systematically adjust narrative polarity and intensity in response to numeric emotion scores, something that cannot be reliably achieved by occasional manual editing.

The system also improves data management by storing both original and generated facial configurations in a unified, feature-based format. The server can maintain indices over feature dimensions and latent cluster identifiers, thereby enabling fast retrieval of face groups for future narrative or visual generation tasks. This unified data model supports incremental training or fine-tuning of the generative models, as the server can easily sample training batches that reflect specific patterns in user-generated faces.

Alternative embodiments are also possible. For example, the server may implement the first generative AI model as a GAN, where a generator network outputs feature vectors from random latent inputs and a discriminator network evaluates whether vectors resemble those from the dataset. The server may condition the generator on the user's original feature vector by concatenating the vector with noise. In another embodiment, the server may employ a diffusion model that iteratively denoises random vectors toward realistic facial feature vectors conditioned on the original vector. Variations in the network depth, width, activation functions, or optimization algorithms are also contemplated. The second generative AI model may be replaced or supplemented by a recurrent neural network, such as a long short-term memory (LSTM) network, if resource constraints favor a lighter architecture.

In all embodiments, the server, the terminal, and the user cooperate, but the core computational improvements reside in the server's specific data structures, feature encodings, latent-space processing, statistical aggregation, prompt sentence construction, and display control generation. These aspects collectively provide a technical solution that goes beyond mere automation of human storytelling and instead improves the way computers represent, generate, and render complex multimodal content.

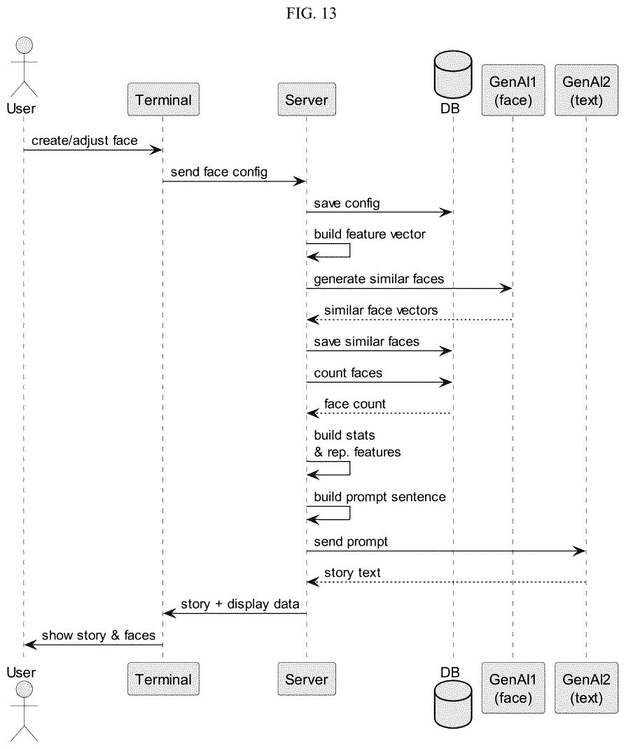

The following describes the processing flow using FIG. 13.

### Step 1:

The terminal displays a graphical user interface for facial configuration.

The terminal uses a browser or native application to render a canvas and a palette of facial components (eyes, noses, mouths, etc.) on a display device.

Input: GUI layout definitions and a component library stored locally or received from the server.

Output: A visible interface allowing selection, placement, and adjustment of facial components.

The terminal draws icons or thumbnails for each facial component and provides interaction controls (click, tap, drag, drop, sliders) so that the user can manipulate the components on the canvas.

### Step 2:

The user creates a facial configuration on the terminal.

The user selects facial components from the palette and drags them onto the canvas, adjusting their position, size, and optionally rotation or style.

Input: User interaction events such as mouse clicks, touch events, and keyboard inputs.

Output: An in-memory facial configuration object containing component identifiers and layout parameters.

The terminal updates this configuration object whenever the user moves or edits a component, storing for each component a type ID, x-y coordinates, a scale factor, and other attributes.

### Step 3:

The terminal transmits structured face image configuration information to the server.

The terminal serializes the in-memory configuration object into structured data, for example, a key-value representation describing selected components and their layout.

Input: The facial configuration object maintained by the terminal.

Output: A network request containing structured face image configuration information sent over a communication interface to the server.

The terminal initiates an HTTP or similar request, embeds the structured data into the request body, and sends it through a network stack to the server.

### Step 4:

The server receives and stores the face image configuration information.

The server accepts the network request, parses the structured data, and performs validation on required fields and value ranges.

Input: Structured face image configuration information received from the terminal.

Output: Validated face image configuration data stored in a storage device and associated with a unique identifier.

The server uses a database management system to execute insert operations, writing the configuration data into a table or collection and returning a face ID.

### Step 5:

The server converts the face image configuration data into numerical feature values and generates a feature vector.

The server retrieves the stored configuration data and maps each component identifier to a predetermined numerical code, while normalizing positional and size values relative to a canonical canvas.

Input: Face image configuration data (component IDs, positions, sizes, and optional rotation or style attributes).

Output: A fixed-length feature vector composed of encoded component codes and normalized layout parameters.

The server concatenates one-hot or index-based encodings for component types with continuous features (normalized coordinates, scales), and optionally applies standardization or dimensionality reduction to form the final feature vector.

### Step 6:

The server inputs the feature vector to a first generative AI model and obtains similar-face feature vectors.

The server loads a trained generative AI model (for example, a variational autoencoder or another generative architecture) and feeds the feature vector into the encoder or conditioning network.

Input: The feature vector representing the user-created face.

Output: A plurality of similar-face feature vectors generated by latent-space sampling and decoding.

The server computes a latent representation of the input, generates nearby latent points by adding structured noise or sampling, and decodes each latent point into a new feature vector using the decoder portion of the generative AI model.

### Step 7:

The server converts generated feature vectors into additional face image configuration data and stores them.

The server interprets each similar-face feature vector by mapping the numeric outputs back to discrete component codes and denormalized layout parameters.

Input: A plurality of similar-face feature vectors produced by the generative AI model.

Output: New face image configuration data entries corresponding to similar faces, stored in the storage device.

The server selects, for each categorical dimension, the most likely component code, rescales normalized coordinates back to pixel positions, and inserts the resulting facial configurations into the database as generated records linked to the base face ID.

### Step 8:

The server checks whether the number of similar-face configurations meets a predetermined threshold.

The server queries the storage device to count all similar-face configuration records associated with the original face ID.

Input: Identifiers or metadata linking generated configurations to the original face.

Output: A count value compared against a predetermined threshold and a decision whether to proceed to narrative generation.

The server executes a count operation, retrieves the result, and if the count is equal to or greater than the threshold, flags the corresponding face group as ready for statistical analysis and story generation.

### Step 9:

The server computes statistical information of facial features from similar-face feature vectors.

The server selects all feature vectors belonging to the group and performs aggregation operations, such as counting the occurrence of each component code and averaging positions and sizes.

Input: A set of similar-face feature vectors associated with an original face.

Output: Statistical summaries including frequency distributions, averages, and variances for facial components and layout attributes.

The server uses vector operations and aggregation algorithms to determine dominant components and typical spatial arrangements that best represent the group.

### Step 10:

The server extracts representative facial features based on the statistical information.

The server identifies, for each facial component type, the code or parameter values that satisfy a selection criterion, such as highest frequency or minimal average distance to all samples.

Input: Statistical information of facial features (frequencies, averages, and dispersion measures).

Output: Representative facial feature data describing typical component types and layout parameters.

The server applies selection and ranking algorithms to the statistics and constructs a structured representation of the representative features to be used for text description.

### Step 11:

The server generates a natural language description of the representative facial features.

The server maps each representative component code and layout pattern to a human-readable phrase using predefined dictionaries or templates.

Input: Representative facial feature data derived from the similar faces.

Output: A textual description phrase such as “large round eyes, small high nose, thin lips.”

The server concatenates phrases corresponding to each component and optionally adds qualifiers based on positional or stylistic attributes.

### Step 12:

The server optionally integrates emotion information from the user into narrative conditions.

The server acquires emotion information, for example via user input or sensor analysis, and encodes it into a structured form such as labels or numeric scores.

Input: Emotion-related data indicating the user's emotional state.

Output: Emotion condition information suitable for inclusion in a prompt sentence.

The server maps raw emotion readings to standardized categories (e.g., “anxious,” “hopeful”) or values, and prepares corresponding language fragments describing the emotional context.

### Step 13:

The server constructs a prompt sentence for narrative generation.

The server combines the natural language description of representative facial features, the number of similar faces, and, when available, the emotion condition information and narrative preferences (e.g., genre, tone, length) into a single prompt sentence.

Input: Facial feature description text, similar-face count, and optional emotion condition and narrative parameters.

Output: A complete prompt sentence in natural language, formatted for input to a text-generating generative AI model.

The server may produce, for example, the following prompt sentences:
“Face features: large round eyes, small high nose, thin lips. Number of similar faces: 1000. Please generate a fantasy story about people who share these features and gain special powers at night.”
“Face features: sharp almond-shaped eyes, long straight nose, wide smiling mouth. Number of similar faces: 500. Please generate a science-fiction story where people with these features are explorers of distant galaxies.”

### Step 14:

The server inputs the prompt sentence to a second generative AI model and receives narrative text.

The server sends the prompt sentence to a language model implemented as a neural network architecture, such as a transformer, and requests text generation.

Input: The prompt sentence describing facial features, similar-face count, and optional emotional and narrative conditions.

Output: Narrative text generated by the language model in response to the prompt sentence.

The server encodes the prompt into tokens, processes them through the language model, and decodes the generated token sequence to produce a coherent story.

### Step 15:

The server generates display control data based on the narrative text and face image configuration data.

The server associates segments of the narrative with corresponding facial configurations or representative faces and defines layout or spatial parameters for rendering.

Input: The narrative text and the face image configuration data, including original and representative facial configurations.

Output: Display control data specifying text layout and visual elements to be displayed on the terminal or virtual reality device.

The server creates, for example, instructions for text positioning, image placement, and, in the case of virtual reality, positions and orientations of avatars in a three-dimensional virtual space.

### Step 16:

The server transmits output data to the terminal, and the terminal presents the narrative and visual content to the user.

The server packages the narrative text and display control data as output data and sends it to the terminal via the communication network. The terminal interprets the display control data and renders the narrative text along with corresponding facial visuals on the display device or in a virtual reality environment.

Input: Output data received from the server, including narrative text and display control data.

Output: A visual and textual presentation on the terminal's display or virtual reality device, which the user can view and interact with.

The terminal draws the story text and images or virtual scenes according to the control instructions, thereby presenting a coherent experience based on the generated narrative and the underlying facial configurations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In the field of computer-implemented content generation, conventional systems that create faces or avatars based on user input generally perform only static image synthesis or simple pattern matching. Such systems typically generate a single image or a small set of images based on predefined templates and do not leverage advanced generative artificial intelligence models in a structured pipeline. As a result, these systems fail to exploit rich feature representations of user-created faces, do not adapt narrative content to user emotion in a systematic manner, and do not tightly integrate story generation with immersive virtual reality presentation.

Specifically, known systems exhibit at least the following technical limitations. First, user-created faces are often handled merely as bitmap images or discrete selections, without extracting quantitative facial feature information that can serve as an input condition or prompt sentence to a generative artificial intelligence model. Consequently, the generative processing is limited to superficial variation and cannot utilize high-dimensional feature vectors or structured prompts to control the behavior of the generative models. Second, when generative artificial intelligence models are used, their input prompts are generally handcrafted and static, rather than being automatically constructed from aggregated feature patterns and user emotion data. This prevents the system from adaptively steering the generative models based on real-time user interaction and does not improve the technical efficiency or controllability of the generative pipeline.

Third, conventional systems that generate stories or “urban legends” typically do so independently of large-scale statistical analysis of generated face features, and they rarely incorporate user emotion signals captured via imaging and audio acquisition devices. As a result, story generation is not dynamically conditioned on the user's actual emotional state, and the system cannot automatically adjust story content and expression style in response to detected emotion. Fourth, while virtual reality display devices are increasingly used for content consumption, existing face-generation and story-generation systems often deliver content as simple video playback or static scenes, without generating scene configuration information that programmatically binds story data, character elements derived from facial feature information, and environment elements into a coherent, parameterized virtual space. From a computer-technology perspective, there is a need for a unified, computer-implemented architecture that (i) converts user-created composite face images into structured facial feature information; (ii) uses such feature information as input conditions or prompt sentences for generative artificial intelligence models to generate large sets of similar face images; (iii) aggregates and analyzes these feature sets to construct detailed prompt sentences for text generative artificial intelligence models; (iv) incorporates automatically inferred user emotion data into those prompt sentences to control story content and style; and (v) generates machine-readable scene configuration information for a virtual reality display device, thereby enabling an immersive experience that is tightly coupled to both facial feature patterns and user emotion. Without such an architecture, computer systems remain limited in their ability to orchestrate generative models, to automatically construct prompts from machine-derived data, and to render the results in an adaptive, immersive environment.

The specific processing by the specific processing unit 290 of the data processing device 12 in Application Example 2 is realized by the following means.

The present invention provides a server comprising a processor configured to provide, via a display device, a user interface that allows a user to select and arrange a plurality of types of facial components on an operation screen so as to generate a composite face image; to extract, from the composite face image or from structured data representing the composite face image, facial feature information by performing image processing, and to generate the facial feature information as numerical data or textual data; to input the facial feature information as an input condition or as a prompt sentence to a generative artificial intelligence model, and to generate, by the generative artificial intelligence model, a plurality of similar face images having a predetermined similarity to the composite face image; to store, for each of the similar face images, the facial feature information or statistical information of the facial feature information, and to determine whether a number of stored similar face images has reached or exceeded a predetermined threshold; to generate, based on the stored facial feature information of the similar face images and patterns of the facial feature information, a prompt sentence defining contents of a story, and to input the prompt sentence to a text generative artificial intelligence model so as to generate story data; to generate emotion data indicating an emotional state of the user by performing emotion estimation processing using facial expression information, audio information, or character input information of the user acquired from an imaging device and an audio acquisition device; to adjust contents and an expression style of the story data according to the emotional state of the user by reflecting the emotion data in the prompt sentence used for generation of the story data; and to generate scene configuration information in a virtual space based on the story data and the similar face images, and to output the scene configuration information to a virtual reality display device so as to present the story data visually or aurally to the user. This enables the computer system to automatically convert user-created composite faces into machine-usable feature representations, to orchestrate generative artificial intelligence models via dynamically constructed prompt sentences that incorporate both aggregated facial feature patterns and emotion data, and to render the resulting story and similar face images as an adaptive, immersive virtual reality experience, thereby improving the technical functioning and controllability of the generative content pipeline.

The term “processor” refers to a hardware computation unit or a combination of hardware computation units, including one or more central processing units, graphics processing units, or other programmable logic devices, that execute instructions to perform the functions described in the system.

The term “display device” refers to any electronic output apparatus capable of visually presenting information to a user, including but not limited to a flat-panel display, a head-mounted display, or a projection device.

The term “user interface” refers to a software-controlled interaction environment presented on the display device that allows the user to provide input and receive output, including graphical controls, menus, and interactive elements for selecting and arranging facial components.

The term “facial component” refers to an individual graphical or parametric element representing a part of a face, such as an eye, a nose, a mouth, an eyebrow, or other facial feature, which can be combined with other facial components to form a composite face image.

The term “operation screen” refers to a specific user interface screen or view presented on the display device, on which the user can manipulate facial components, including selecting, placing, resizing, and rotating the components to construct a composite face image.

The term “composite face image” refers to a synthesized representation of a face generated by arranging multiple facial components according to user input, and may be represented as bitmap image data or as structured parametric data.

The term “structured data representing the composite face image” refers to data organized in a predetermined format, such as a hierarchical or key-value structure, that encodes attributes of the composite face image, including types, positions, sizes, and orientations of facial components.

The term “image processing” refers to a computational operation or sequence of operations applied to image data, including detection, segmentation, transformation, and feature extraction, executed by the processor using software libraries or algorithms.

The term “facial feature information” refers to numerical or symbolic information that characterizes the structure or appearance of a face, including but not limited to coordinates of facial landmarks, distances and angles between facial points, and embedding vectors representing facial characteristics.

The term “numerical data” refers to data expressed as one or more numerical values, such as integers, floating point values, arrays, or vectors, that can be processed mathematically or statistically by the processor.

The term “textual data” refers to data expressed as human-readable or machine-readable text strings, including descriptive phrases or encoded labels that describe characteristics of the composite face image or related information.

The term “input condition” refers to data or parameters supplied to a generative model that constrain or guide the generation process, including facial feature information, random seeds, or configuration parameters.

The term “prompt sentence” refers to a textual instruction or query provided to a generative artificial intelligence model, describing desired characteristics, constraints, or styles of an output to be generated by the model.

The term “generative artificial intelligence model” refers to a machine learning model configured to generate new data samples, such as images or other content, based on input conditions or prompt sentences, and includes generative adversarial networks, diffusion models, and other generative architectures.

The term “similar face image” refers to a face image generated by the generative artificial intelligence model that shares predetermined similarity characteristics with the composite face image, as measured by facial feature information or similarity metrics.

The term “predetermined similarity” refers to a condition in which similarity between two sets of facial feature information meets or exceeds a predefined criterion or threshold, such as a distance metric being below a specified value.

The term “statistical information of the facial feature information” refers to aggregated numerical descriptors derived from multiple instances of facial feature information, including averages, variances, cluster centers, or other statistical measures.

The term “predetermined threshold” refers to a fixed or configurable numeric value used as a criterion for decision-making by the processor, such as a minimum number of stored similar face images required to initiate story generation.

The term “story” refers to a sequence of events, characters, and narrative elements expressed as text or structured data, which may include genres such as myths, legends, or other narrative forms.

The term “story data” refers to a machine-readable representation of a story generated by a text generative artificial intelligence model, including text strings and, optionally, structural annotations such as chapter boundaries or scene markers.

The term “text generative artificial intelligence model” refers to a machine learning model configured to generate text outputs, such as sentences, paragraphs, or documents, based on an input prompt sentence or other conditioning information.

The term “imaging device” refers to any device capable of acquiring image data of the user, including cameras integrated into terminals, head-mounted displays, or external imaging sensors.

The term “audio acquisition device” refers to any device capable of acquiring audio data from the user, including microphones integrated into computing terminals, headsets, or external audio sensors.

The term “emotion estimation processing” refers to a computational procedure that analyzes input data, such as facial expressions, voice signals, or textual input, to infer or classify an emotional state of the user.

The term “emotion data” refers to information representing an inferred emotional state of the user, including one or more emotion labels, such as joy, fear, or surprise, and optionally associated confidence scores or intensity values.

The term “emotional state of the user” refers to a psychological condition or affective state of the user at a given time, as inferred from sensor data via emotion estimation processing.

The term “expression style of the story data” refers to stylistic properties of the generated story, including tone, atmosphere, level of formality, narrative pace, and genre characteristics, which can be adjusted based on emotion data.

The term “virtual space” refers to a computer-generated three-dimensional or pseudo-three-dimensional environment in which objects, characters, and scenes are represented and rendered for display to the user.

The term “scene configuration information” refers to data describing a configuration of a scene in the virtual space, including positions, shapes, and attributes of characters and environment elements, camera parameters, and temporal sequences of events.

The term “virtual reality display device” refers to a device capable of presenting the virtual space to the user in an immersive manner, such as a head-mounted display or any other display apparatus configured for virtual reality or mixed reality presentation.

The term “character element” refers to a representation of an entity in the virtual space corresponding to a person, creature, or avatar, whose appearance may be derived from or associated with similar face images and their facial feature information.

The term “environment element” refers to a representation of a background, object, location, or other non-character component in the virtual space, which forms part of the surroundings in which the story is presented.

The term “immersive virtual reality experience” refers to a user experience in which the user perceives being present within the virtual space through visual, auditory, and optionally interactive stimuli, such that the user can perceive the story as occurring around them.

In one embodiment, a server cooperates with one or more terminals to implement a system that generates similar face images, emotion-adaptive story data, and immersive virtual reality presentations based on user-created composite face images. The server includes at least one processor, a memory storing programs and data, a communication interface, and access to one or more hardware accelerators such as graphics processing units. The terminal includes a display device, an imaging device, an audio acquisition device, an input device, and a communication interface. The user operates the terminal to construct composite face images and to experience the generated stories in a virtual space.

The terminal executes an application program that provides a user interface on the display device. The terminal uses a cross-platform user interface framework such as a component-based user interface library to render an operation screen on which the user can select facial components, including but not limited to eyes, noses, mouths, eyebrows, and hair shapes. The terminal maintains an internal data structure representing the composite face as a set of facial components with attributes. In one example, the terminal represents the composite face using a hierarchical object structure including fields for a component identifier, a two-dimensional position, a scale factor, a rotation angle, and style parameters such as color or “smile intensity.” The terminal updates this structure whenever the user drags, rotates, or resizes a component.

The terminal converts the internal composite-face structure into structured data suitable for server-side processing. The terminal, for example, serializes the composite face into key-value pairs indicating the types and positions of facial components and attaches a session identifier, a timestamp, and device metadata. The terminal transmits this structured data to the server over a network using a transport protocol such as HTTP over a secure channel. By normalizing the composite face into a consistent, machine-interpretable structure, the terminal enables the server to perform deterministic, repeatable computations across heterogeneous devices.

The server receives the structured composite-face data and reconstructs either a two-dimensional raster image or a parametric representation of the face. In one embodiment, the server accesses a library of facial component sprites stored in a storage device. The server composites these sprites into a base face image using an image-processing library such as an image manipulation toolkit or a computer vision framework. The server uses deterministic alpha blending and coordinate transforms so that the same structured data always yields the same base face image. This precise reconstruction is critical for reproducible feature extraction and for maintaining a stable mapping from user actions to model inputs.

The server extracts facial feature information from the base face image or from the structured data. In one embodiment, the server uses a facial landmark detection algorithm implemented with a computer vision toolkit or a facial analysis library. The server detects a predetermined number of facial landmark points, for example 68 or 81 points corresponding to eye corners, nose bridge, nostrils, mouth corners, and jawline. The server then normalizes these landmark coordinates by translating them so that the face center lies at the origin, and scaling them so that an inter-pupil distance becomes a constant reference length. The server concatenates the normalized coordinates into a feature vector. The server may further augment this feature vector with additional features such as eye shape ratios, mouth openness angle, or curvature of the eyebrows. As a result, the server generates numerical facial feature information representing the composite face in a high-dimensional, model-compatible vector space.

The server optionally converts the numerical facial feature information into textual feature descriptions. In such a case, the server maps numerical ranges to qualitative descriptors using predefined rule sets. For example, the server may convert a large eye width-to-height ratio into the descriptor “large round eyes,” a small nose length into “small pointed nose,” and a wide mouth curvature into “smiling mouth.” The server combines these descriptors into a prompt sentence used as an input condition to a generative AI model. One example of such a prompt sentence is:
“Generate 20 face images that are similar to a face with large round eyes (eye type 1), a small pointed nose (nose type 2), and a medium smiling mouth (mouth type 3).”

By mapping high-dimensional vectors into structured natural language descriptions, the server permits generative AI models that are primarily text-conditioned to be tightly controlled by precisely computed, machine-derived features.

The server uses the facial feature information as an input condition or prompt sentence to a generative AI model that outputs similar face images. In one embodiment, the server employs a generative adversarial network architecture such as a style-based generator. The generative AI model comprises a mapping network that transforms an input latent vector into an intermediate latent space, and a synthesis network that progressively generates an image from coarse to fine resolutions. The server encodes the facial feature vector into a latent code by feeding the facial feature vector through a learned encoder network or by projecting the feature vector into the latent space using linear and non-linear transformations. The server then samples several latent vectors in a neighborhood around the encoded latent point, for example by adding Gaussian noise vectors scaled by a small factor.

The server uses the mapping network of the generative AI model to transform each sampled latent vector into an intermediate latent representation, and then applies the synthesis network to generate a plurality of similar face images. Because the server restricts sampling around a specific, feature-derived latent point, the generated faces share predetermined similarity characteristics with the composite face. This technique differs from a brute force human-driven selection of parameters: the server uses a non-intuitive, model-specific latent geometry learned from large-scale training data to produce faces that maintain key facial traits while exploring the local manifold of variations efficiently.

The server calculates similarity between the composite face and each generated similar face by computing a distance between facial feature vectors, such as a Euclidean distance or a cosine distance in the embedding space. The server may discard generated faces that do not meet a similarity threshold, thereby improving quality and relevance. The server stores each accepted similar face image and its feature vector in a database, along with metadata such as the originating user, the composite face identifier, and the timestamp. The server incrementally updates a counter representing the number of stored similar faces associated with a given feature cluster or category.

The server determines when the number of similar face images has reached a predetermined threshold. For example, the server may wait until one thousand similar faces have been accumulated for a given combination of feature characteristics. Upon reaching the threshold, the server aggregates the facial feature information across the stored similar faces. The server, for instance, uses a clustering algorithm such as k-means or Gaussian mixture modeling to cluster feature vectors into subgroups. The server computes cluster centroids and variances, thereby extracting stable patterns such as “most faces share high eye openness and strong smile curvature.” The server converts these statistical patterns into a high-level description that can be used in a prompt sentence for a text generative AI model.

The server constructs a prompt sentence for a text generative AI model based on the aggregated facial feature patterns. In one example, the server generates the following prompt sentence:
“Use the features of one thousand faces that share large round eyes, small pointed noses, and smiling mouths to create a myth-like story. The story should explain why people with this face shape are believed to be legendary figures from ancient times.”

The server then transmits this prompt sentence to a text generative AI model. In one embodiment, the text generative AI model is a transformer-based neural network with multiple self-attention layers, trained on a large corpus of narrative texts. The server passes the prompt sentence as an input sequence of tokens to the transformer, which processes the sequence through stacked attention layers and feed-forward layers to generate a probability distribution over possible next tokens. The server decodes the output using sampling techniques such as top-k or nucleus sampling to create coherent paragraphs of story data. The server may restrict the generation length, adjust a temperature parameter to control randomness, and inject additional control tokens to specify style or genre.

The terminal acquires emotion-related signals from the user during interaction with the similar face images or the narrative output. The terminal uses the imaging device to capture frames of the user's face, the audio acquisition device to capture the user's voice, and the input device to record textual comments or explicit feedback. The terminal pre-processes these signals, for example, by resizing video frames, extracting spectrograms from audio, and normalizing text for sentiment analysis. The terminal sends these preprocessed data streams to the server or invokes a network-based emotion recognition service.

The server performs emotion estimation processing on the received signals. In one embodiment, the server uses a convolutional neural network to process face images, where the network outputs probabilities for a set of emotions such as joy, fear, anger, and surprise. The server uses a recurrent or transformer-based audio analysis model to classify emotional tone in the user's voice and uses a text classification model to detect sentiment in the user's comments. The server fuses these emotion predictions, for example, by computing a weighted average of the probabilities from each modality. The server then determines an overall emotional state of the user and represents it as emotion data including an emotion label and an intensity score.

The server uses the emotion data to adjust the content and expression style of the story data. To achieve this, the server modifies the prompt sentence supplied to the text generative AI model by adding emotion-related instructions. For example, if the detected emotion is joy, the server may construct a prompt sentence such as:
“Based on one thousand faces that have large round eyes, small pointed noses, and smiling mouths, and considering that the user feels joy, create a positive urban legend. Describe why people with this face are believed to bring happiness and good fortune.”

If the detected emotion is fear, the server may instead construct a prompt sentence such as:
“Based on one thousand faces that have large, reflective eyes and almost expressionless mouths, and considering that the user feels fear, create a suspenseful urban legend. Emphasize mysterious and unsettling elements that match a fearful mood.”

By algorithmically embedding the emotion data into the prompt sentence, the server causes the text generative AI model to modulate narrative tone, vocabulary, and plot structure in a way that cannot be readily achieved by manual rule-based systems. This dynamic conditioning on quantified emotion constitutes a non-conventional application of generative models, improving alignment between generated stories and the user's state and reducing the need for repeated human intervention or manual scriptwriting.

The server generates scene configuration information for virtual reality presentation based on the story data and the similar face images. The server parses the story text to identify entities, locations, and events, for example, using natural language processing techniques such as named entity recognition and dependency parsing. The server associates certain characters in the story with selected similar face images, thereby transforming static images into three-dimensional character elements. The server uses a mapping between facial feature information and 3D facial rig parameters to drive facial animation in a 3D engine. In one embodiment, the server outputs a JSON or other structured description of the virtual space, including character positions, motion paths, camera trajectories, lighting parameters, and environmental assets.

The terminal, when functioning as a virtual reality device, receives the scene configuration information and uses a real-time 3D engine to render the virtual space. The terminal loads 3D models corresponding to character elements and environment elements, applies textures and animations, and updates the rendering based on head pose and user interactions. The user perceives the story as an immersive virtual reality experience in which characters visually reflect the derived similar face images. The technical effect is not limited to narrative enjoyment: the system uses virtual reality rendering pipelines in a controlled way to present model-generated outputs, closing the loop between AI computation and hardware-based display control.

The described configuration produces several technical advantages. The server reduces communication overhead by transmitting compact feature vectors and structured scene configuration information instead of full-resolution video streams. The server improves computation efficiency by reusing stored feature vectors and statistical aggregates, removing the need to recompute features for every new story generation. The server increases story relevance and coherence by using high-dimensional feature clusters and emotion data as constraints, which leads to more precise prompt sentences than generic human-authored prompts. The generative AI models are used according to specific architectures and training strategies, including supervised and self-supervised training with loss functions such as adversarial loss, reconstruction loss, and cross-entropy loss. The server updates model weights during training based on gradient descent, adjusting parameters to minimize these losses over large training sets of human faces and stories.

The server differs from a simple automation of human tasks because it uses machine-learned latent spaces and statistical aggregation that cannot be reproduced by straightforward manual operations. The server employs non-obvious rules to translate numerical patterns in feature space into language-level instructions for generative models, optimizing both generation quality and computational resource usage. For example, by restricting generation to a local latent region defined by actual user-created features and by pre-filtering generated faces according to measured similarity, the server avoids unnecessary model invocations and reduces the rate of off-topic outputs. This targeted generation strategy improves throughput and reduces wasted GPU computation, thereby enhancing the operational efficiency of the generative content pipeline.

In alternative embodiments, the server may use different generative AI models, such as diffusion-based image generators that perform iterative denoising over a fixed number of time steps. In such embodiments, the server encodes facial feature information into conditional guidance vectors that influence the denoising direction at each step, producing samples aligned with the composite face characteristics. The server may also use alternative network architectures for emotion recognition, including graph convolutional networks for facial action units or hybrid multimodal transformers that jointly process video, audio, and text sequences. These variations still operate within the same overall framework: facial feature information and emotion data are systematically translated into prompt sentences and input conditions that tightly control the behavior of generative models, and the outputs are realized as scene configuration information for immersive devices.

In other embodiments, the terminal may perform some feature extraction locally, for example using a lightweight facial landmark detector, and send only normalized feature vectors to the server. This reduces network load and latency, which is particularly beneficial for mobile or wireless environments. The server, in turn, may cache recently used prompt sentence fragments and cluster assignments to reduce recomputation overhead. Such design choices contribute to improved real-time responsiveness and scalability when multiple users simultaneously interact with the system.

Through these embodiments and variations, the server and the terminal cooperate to implement a concrete, technical process that transforms user-created composite faces and sensed emotion into structured feature representations, generative AI inputs, and virtual reality outputs. The system therefore improves computer functionality in the specific context of generative content orchestration, providing enhanced control, efficiency, and quality of AI-generated faces and stories, and enabling immersive experiences that are technically grounded in computed features and model architectures rather than in mere human scripting.

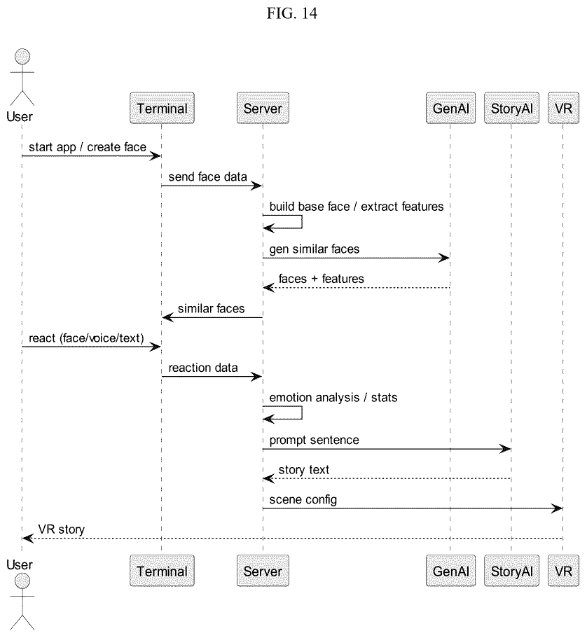

The following describes the processing flow using FIG. 14.

### Step 1:

The user launches an application on the terminal and starts a new face-creation session.

The input is a user action to start the application.

The terminal loads a user interface layout and component definitions from local storage and, if necessary, requests initial configuration data from the server.

The terminal outputs an operation screen on the display device showing available facial components (eyes, noses, mouths, etc.) and an empty face canvas.

### Step 2:

The user selects and arranges facial components on the operation screen to form a composite face.

The input is the user's touch or pointer operations, including taps on component icons and drag-and-drop gestures on the canvas.

The terminal updates an internal composite-face data structure by adding or modifying component entries with attributes such as component type, position, scale, rotation, and style parameters.

The terminal outputs an updated visual rendering of the composite face on the display device and an updated in-memory representation of the composite face.

### Step 3:

The terminal converts the composite-face data structure into structured data suitable for transmission to the server.

The input is the internal composite-face structure containing component identifiers and geometric parameters.

The terminal performs data processing by mapping internal fields to a standardized schema, normalizing coordinate ranges, and encoding attributes into key-value pairs.

The terminal outputs structured composite-face data that includes a session identifier, a timestamp, device metadata, and facial component information.

### Step 4:

The terminal transmits the structured composite-face data to the server.

The input is the structured composite-face data created in Step 3.

The terminal performs data processing by serializing the structured data into a message format and attaching authentication tokens or user identifiers in the headers.

The terminal sends the serialized data over a communication network using a protocol such as HTTPS and outputs a network request that reaches the server.

### Step 5:

The server receives and validates the structured composite-face data.

The input is the network request from the terminal containing the structured composite-face data.

The server parses the message, checks that required fields (component identifiers, positions, etc.) are present and valid, and verifies authentication information.

The server outputs a validated composite-face record and stores it in a persistent storage device with an assigned face identifier.

### Step 6:

The server reconstructs or composes a base face image from the structured composite-face data.

The input is the validated composite-face record including facial component identifiers and geometry.

The server performs data processing by loading image assets for each facial component from secondary storage and compositing them into a single raster image using an image-processing library.

The server outputs a base face image that visually corresponds to the user-created composite face.

### Step 7:

The server extracts numerical facial feature information from the base face image.

The input is the base face image generated in Step 6.

The server performs data processing by running a facial landmark detection algorithm to find predefined key points (such as eye corners and mouth corners), normalizing their coordinates, and concatenating them into a feature vector.

The server outputs a high-dimensional numerical facial feature vector representing geometric and structural characteristics of the composite face.

### Step 8:

The server optionally converts the numerical facial feature vector into a textual description.

The input is the numerical facial feature vector from Step 7.

The server performs data processing by comparing feature values against predefined thresholds and rules (for example, eye width ratios or mouth curvature) and mapping them to qualitative terms such as “large eyes” or “narrow mouth.”

The server outputs a textual feature description that summarizes the composite face in natural language form.

### Step 9:

The server prepares input conditions or a prompt sentence for a generative AI model that generates similar faces.

The input is the numerical facial feature vector and, optionally, the textual feature description from Steps 7 and 8.

The server performs data processing by either (a) encoding the feature vector into a latent space representation via an encoder network or (b) assembling a prompt sentence that incorporates the textual description.

The server outputs an input condition for the generative AI model, which may consist of a latent code and/or a prompt sentence such as “Generate 20 face images that are similar to a face with large round eyes, a small pointed nose, and a medium smiling mouth.”

### Step 10:

The server generates multiple similar face images using the generative AI model.

The input is the generative model input condition from Step 9.

The server performs data processing by sampling multiple latent vectors around the encoded latent point, feeding them through the generative model's mapping and synthesis networks, and creating image outputs.

The server outputs a set of similar face images and associated feature vectors, representing variations that preserve predetermined similarity to the original composite face.

### Step 11:

The server evaluates and filters the generated similar face images based on similarity criteria.

The input is the set of generated similar face images and their feature vectors from Step 10, plus the original facial feature vector.

The server performs data processing by computing similarity scores (such as Euclidean or cosine distances) between each generated feature vector and the original feature vector, and discarding those that do not meet a similarity threshold.

The server outputs a filtered subset of similar face images and feature vectors that satisfy the similarity condition.

### Step 12:

The server stores the filtered similar face images and updates accumulation statistics.

The input is the filtered similar face images and their feature vectors from Step 11.

The server performs data processing by writing the images and vectors into a database or storage system, tagging them with user and face identifiers, and updating counters that track how many similar faces have been stored for each feature category.

The server outputs an updated statistics record containing counts and possibly cluster assignments for the accumulated similar faces.

### Step 13:

The server determines whether the number of accumulated similar face images has reached a threshold for story generation.

The input is the updated statistics record from Step 12, including the count of similar faces for the current feature category.

The server performs data processing by comparing the count against a predetermined threshold (for example, 1000 faces) and generating a Boolean decision.

The server outputs a decision indicating whether to proceed to story generation or to continue only with image generation.

### Step 14:

The terminal receives and displays the current similar face images for user inspection.

The input is a server response that includes references or data for the filtered similar face images from Step 11 or Step 12.

The terminal performs data processing by downloading the image data if required, decoding the image format, and arranging the images in a gallery or scrollable layout.

The terminal outputs a visual presentation of the similar face images on the display device for the user to view and optionally select favorites or provide feedback.

### Step 15:

The terminal captures user reactions and emotion-related signals while the user views the similar face images or related content.

The input is the user's physical response, such as facial expressions, vocal utterances, and text comments.

The terminal performs data processing by capturing video frames from the imaging device, audio signals from the audio acquisition device, and textual input from UI elements, and by optionally extracting simple features such as frame-level face bounding boxes or audio energy.

The terminal outputs preprocessed reaction data that is ready to be transmitted to the server for emotion estimation.

### Step 16:

The terminal or server executes emotion estimation processing on the reaction data.

The input is the preprocessed reaction data from Step 15.

The server performs data processing by applying trained neural network models to image, audio, and text streams to predict emotion probabilities and then fuses these probabilities across modalities.

The server outputs emotion data including an emotion label (such as joy or fear) and one or more confidence or intensity scores that characterize the user's emotional state.

### Step 17:

The server aggregates facial feature information from accumulated similar face images and combines it with the emotion data to build a story-generation context.

The input is the feature vectors and statistics for the stored similar faces from Steps 11 and 12, plus the emotion data from Step 16.

The server performs data processing by clustering feature vectors, calculating centroids and variances, and selecting dominant characteristics that define the face group. The server then associates these characteristics with the emotion label.

The server outputs a context representation that encodes both feature patterns (for example, “large round eyes and smiling mouths”) and emotional cues (for example, “user feels joy”).

### Step 18:

The server constructs a prompt sentence for the text generative AI model based on the story-generation context.

The input is the context representation from Step 17.

The server performs data processing by filling predefined template structures with feature descriptors and emotion descriptors, and by appending instructions about narrative style and genre.

The server outputs a prompt sentence such as “Based on one thousand faces that have large round eyes, small pointed noses, and smiling mouths, and considering that the user feels joy, create a positive urban legend that explains why people with this face are believed to bring happiness and good fortune.”

### Step 19:

The server generates story data using the text generative AI model.

The input is the prompt sentence built in Step 18.

The server performs data processing by tokenizing the prompt, feeding it through a transformer-based text generation network, and decoding the output token sequences into human-readable text with controlled sampling parameters.

The server outputs story data that comprises narrative text describing a story or urban legend aligned with the facial feature patterns and the user's emotional state.

### Step 20:

The server converts the story data and selected similar face images into scene configuration information for a virtual space.

The input is the story data from Step 19 and a subset of similar face images and feature vectors.

The server performs data processing by parsing the text to identify entities and events, mapping selected similar faces to character roles, and generating structured scene descriptions that specify character positions, animations, environmental settings, and temporal sequences.

The server outputs scene configuration information that can be interpreted by a virtual reality engine to render an immersive scenario.

### Step 21:

The terminal, functioning as a virtual reality device, renders the virtual space according to the scene configuration information.

The input is the scene configuration information from Step 20.

The terminal performs data processing by loading appropriate 3D assets, mapping facial feature vectors to rig controls for character faces, updating camera positions and lighting, and drawing frames based on user head motion and interactions.

The terminal outputs a series of rendered images and audio signals on the virtual reality display device, presenting the story as an immersive experience to the user.

### Step 22:

The user interacts with the virtual space and provides further implicit or explicit feedback.

The input is the rendered virtual reality experience and interactive elements exposed by the terminal.

The user may move within the virtual space, focus attention on certain characters, speak, or use controllers to trigger actions, and the terminal captures these interactions as additional reaction data.

The terminal outputs new reaction data and interaction logs that can be sent back to the server, enabling iterative refinement of similar face generation, prompt sentence construction, and story adaptation in subsequent cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

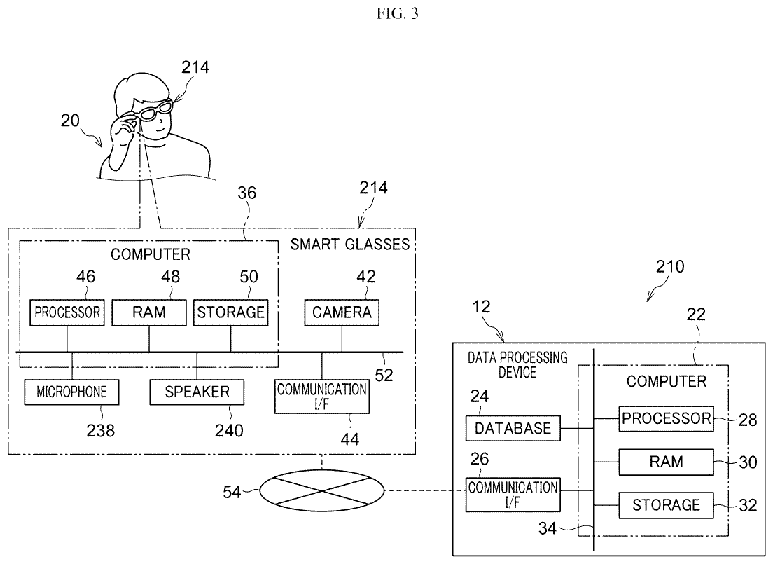

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

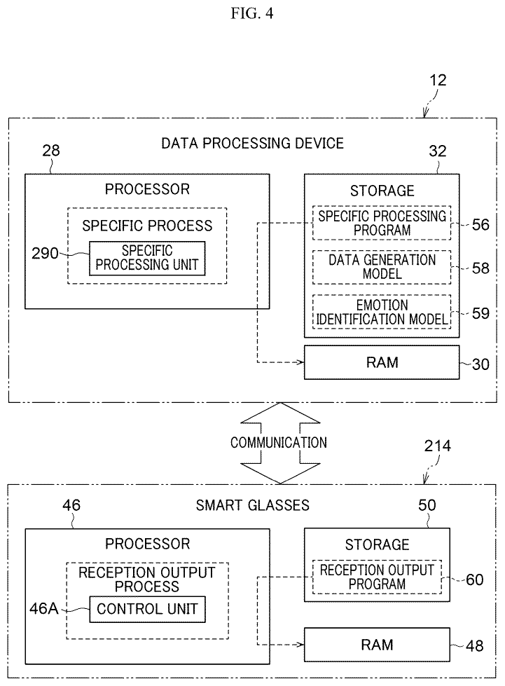

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

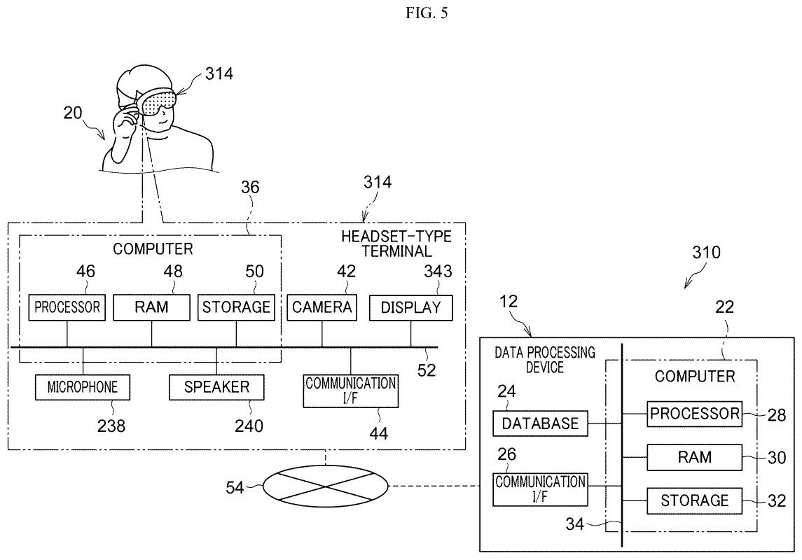

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

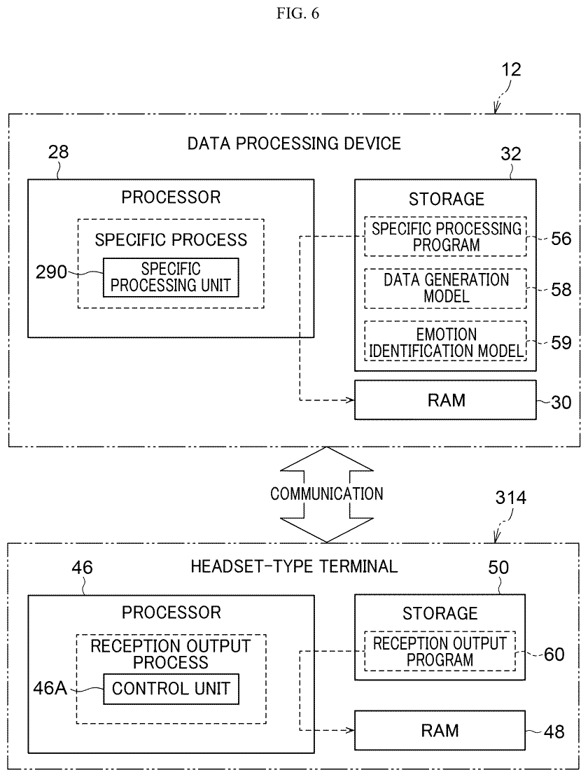

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

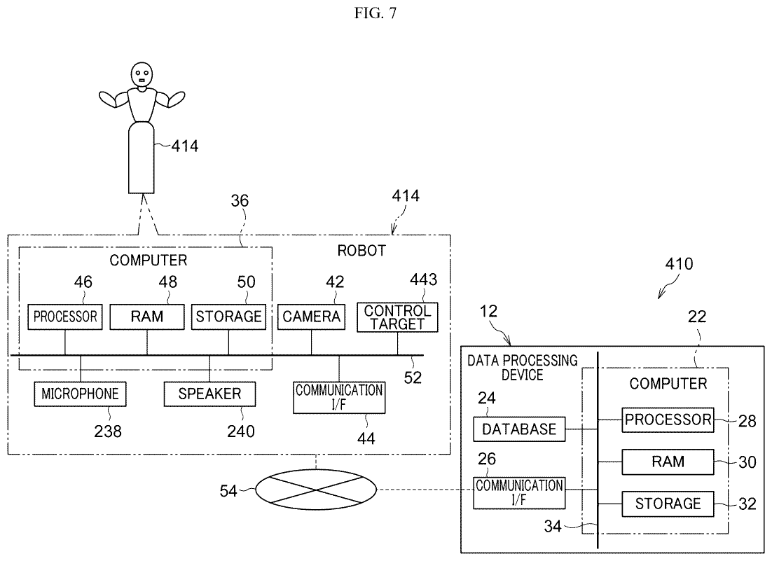

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

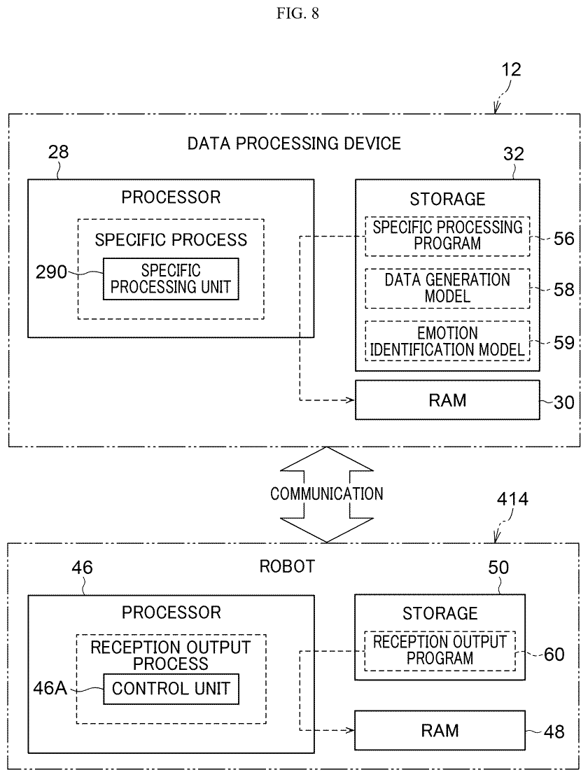

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

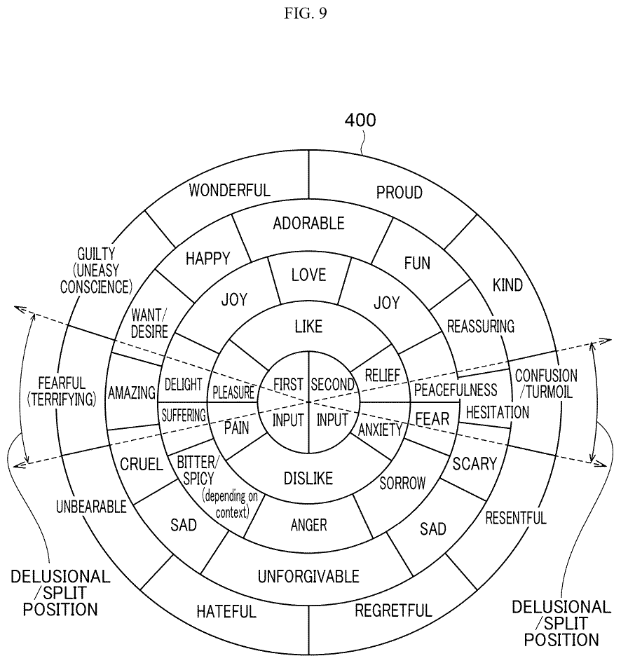

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

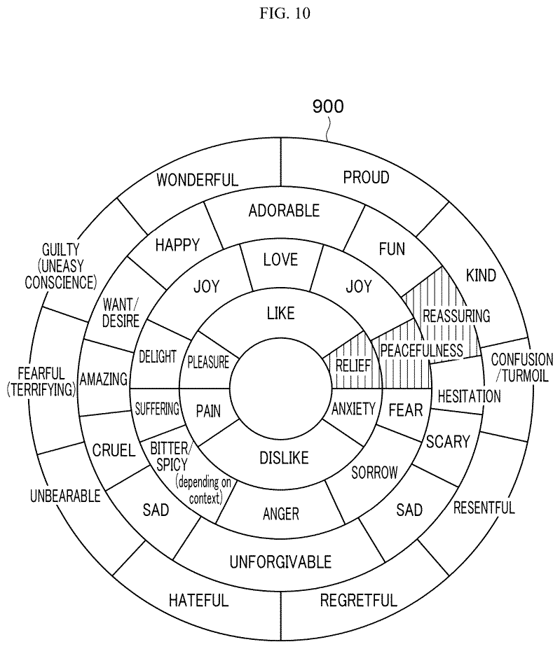

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
cause a terminal device to provide a user interface that allows a participant to select facial components on a display screen and combine the facial components to generate facial configuration information,
cause the terminal device to transmit the facial configuration information as structured data to an information processing apparatus, receive the structured data at the information processing apparatus, encode the structured data as numerical facial feature data, and store the numerical facial feature data as feature vectors in the storage device,
input the numerical facial feature data as conditioning information to a generative artificial intelligence model together with random information, execute the generative artificial intelligence model on computation hardware to generate a plurality of facial image data items similar to the numerical facial feature data, and repeatedly store the plurality of facial image data items and corresponding numerical facial feature data in the storage device,
determine whether a number of the facial image data items stored in the storage device is greater than or equal to a predetermined number, and when the number is greater than or equal to the predetermined number, aggregate the corresponding numerical facial feature data to generate feature description text and generate a prompt sentence including the feature description text,
input the prompt sentence as input information to a text generation artificial intelligence model, execute the text generation artificial intelligence model to generate story content based on the plurality of numerical facial feature data, and transmit the story content to the terminal device for presentation to the participant,
acquire emotion information indicating an emotional state of the participant, adjust contents of at least one of the prompt sentence and the story content based on the emotion information, and generate adjusted story content as presentation data, and
transmit the presentation data to a virtual space display device so that the virtual space display device displays the adjusted story content and the plurality of facial image data items in a virtual reality space.

### (Supplementary 2)

The system according to supplementary 1,
wherein the processor is configured to integrate the numerical facial feature data stored in the storage device and the emotion information indicating the emotional state of the participant as different types of feature information, to generate the prompt sentence based on the integrated feature information, and to input the prompt sentence to the text generation artificial intelligence model so that the story content reflecting the different types of feature information is generated.

### (Supplementary 3)

The system according to supplementary 1,
wherein the processor is configured to transmit virtual space display data including the story content and the plurality of facial image data items to a virtual reality display apparatus including at least one of a three-dimensional image display apparatus and a head-mounted display apparatus, and to cause the virtual reality display apparatus to display the story content in the virtual reality space in a time sequence.

### Application Example 1

### (Supplementary 1)

A system comprising a processor,
wherein the processor is configured to
provide, to a terminal, a display interface and an input interface that allow a user to select a plurality of types of facial components and combine the facial components to generate facial image data,
convert attribute information relating to the facial image data, which is acquired from the terminal, into numerical information and generate feature data of the facial image data by using the numerical information,
generate a descriptive text that describes the facial image data based on the feature data, and generate a prompt sentence including the descriptive text and an instruction relating to a generation quantity,
transmit request information including the prompt sentence to a generation information processing apparatus, cause a generative artificial intelligence model operating on the generation information processing apparatus to receive the prompt sentence, and cause the generative artificial intelligence model to generate a plurality of facial data similar to the facial image data,
store the plurality of facial data acquired from the generative artificial intelligence model in a storage device, aggregate a stored number of the plurality of facial data, and determine whether the stored number is equal to or greater than a predetermined threshold,
when it is determined that the stored number is equal to or greater than the predetermined threshold, analyze feature data of the plurality of facial data, generate a story-generation prompt sentence including a description of group characteristics based on the feature data, and input the story-generation prompt sentence to a natural-language generative artificial intelligence model to generate story data,
acquire an emotional state of the user by using an emotion acquisition function, change content of at least one of the story-generation prompt sentence and the story data in accordance with the acquired emotional state of the user, and thereby generate story data adapted to the emotional state of the user, and
place the story data and the plurality of facial data in a virtual three-dimensional space and output display data of the virtual three-dimensional space to a display device so that the virtual three-dimensional space is presented to the user.

### (Supplementary 2)

The system according to supplementary 1,
wherein the processor is configured to
cause a prompt generation function to generate a prompt sentence including both feature data relating to the plurality of facial data and information relating to the emotional state acquired by the emotion acquisition function, and cause a story-generation function to use the prompt sentence as input to the natural-language generative artificial intelligence model to generate the story data.

### (Supplementary 3)

The system according to supplementary 1,
wherein the processor is configured to
transmit the display data relating to the virtual three-dimensional space, including the story data and the plurality of facial data, to a head-mounted display device so that the head-mounted display device presents the virtual three-dimensional space to the user.

### Example 2

### (Supplementary 1)

A system comprising a processor,
wherein the processor is configured to
provide a user interface that allows a participant to select a plurality of types of facial components on a display screen of a display device, to manipulate at least a position, a size, and a shape of the facial components, and to generate face image configuration information and transmit the face image configuration information as structured data,
receive the face image configuration information, store the face image configuration information as face image configuration data in a storage device, associate the facial components with predetermined codes, normalize the position and the size, and convert the face image configuration information into numerical feature values to generate a feature vector,
input the feature vector to a generative artificial intelligence model, generate a plurality of latent representations close to the feature vector in a latent space of the generative artificial intelligence model, generate similar-face feature vectors from the plurality of latent representations, and additionally store the similar-face feature vectors as the face image configuration data in the storage device,
count a number of similar-face feature vectors stored in the storage device, determine that the number is equal to or greater than a predetermined threshold, calculate statistical information of facial features based on the plurality of similar-face feature vectors, and extract representative facial features from the statistical information,
generate a prompt sentence including a natural language expression describing the representative facial features and condition information of a narrative, based on the representative facial features and the number of the similar-face feature vectors, and input the prompt sentence to a text-generating generative artificial intelligence model to generate narrative text, and
generate output data including the narrative text, transmit the output data to a terminal device, and cause the terminal device to display the narrative text.

### (Supplementary 2)

The system according to supplementary 1,
wherein the processor is configured to
obtain emotion information indicating an emotional state of the participant, and generate the prompt sentence including the emotion information in addition to the natural language expression describing the representative facial features, so that content of the narrative text generated by the text-generating generative artificial intelligence model is adjusted in accordance with the emotion information.

### (Supplementary 3)

The system according to supplementary 1,
wherein the processor is configured to
convert the narrative text and the face image configuration data into display control data for a three-dimensional virtual space, transmit the display control data to a virtual reality display device, and cause the virtual reality display device to present content including the face image configuration data as visual information in the virtual space corresponding to the narrative text.

### Application Example 2

### (Supplementary 1)

A system comprising a processor,
wherein the processor is configured to
provide, via a display device, a user interface that allows a user to select and arrange a plurality of types of facial components on an operation screen so as to generate a composite face image,
extract, from the composite face image or from structured data representing the composite face image, facial feature information by performing image processing, and generate the facial feature information as numerical data or textual data,
input the facial feature information as an input condition or as a prompt sentence to a generative artificial intelligence model, and generate, by the generative artificial intelligence model, a plurality of similar face images having a predetermined similarity to the composite face image,
store, for each of the similar face images, the facial feature information or statistical information of the facial feature information, and determine whether the number of stored similar face images has reached or exceeded a predetermined threshold,
generate, based on the stored facial feature information of the similar face images and patterns of the facial feature information, a prompt sentence defining contents of a story, and input the prompt sentence to a text generative artificial intelligence model so as to generate story data,
generate emotion data indicating an emotional state of the user by performing emotion estimation processing using facial expression information, audio information, or character input information of the user acquired from an imaging device and an audio acquisition device,
adjust contents and an expression style of the story data according to the emotional state of the user by reflecting the emotion data in the prompt sentence used for generation of the story data, and
generate scene configuration information in a virtual space based on the story data and the similar face images, and output the scene configuration information to a virtual reality display device so as to present the story data visually or aurally to the user.

### (Supplementary 2)

The system according to supplementary 1,
wherein the processor is configured to generate the prompt sentence by combining a plurality of types of data including the stored facial feature information of the similar face images and the emotion data of the user, and to input the prompt sentence to the text generative artificial intelligence model so as to generate the story data based on a group of the similar face images and the emotional state of the user.

### (Supplementary 3)

The system according to supplementary 1,
wherein the processor is configured to determine, based on the story data and feature information associated with the similar face images, character elements and environment elements in the virtual space, generate the scene configuration information including the character elements and the environment elements, and transmit the scene configuration information to the virtual reality display device so as to present the story data to the user as an immersive virtual reality experience.

What is claimed is:

1. A system comprising:
circuitry configured to:
cause a terminal device to provide a user interface that allows a participant to select facial components and combine the facial components to generate facial configuration information via a communication interface coupled to a packet-switched network, receive the facial configuration information as structured data from the terminal device, encode the structured data as numerical facial feature data, and store the numerical facial feature data as feature vectors in a memory;
input the numerical facial feature data as conditioning information together with random information to a generative AI model, execute the generative AI model to generate a plurality of facial image data items similar to the numerical facial feature data, and store the plurality of facial image data items and corresponding numerical facial feature data in the memory;
determine whether a number of the facial image data items stored in the memory is greater than or equal to a predetermined threshold and, when the number is greater than or equal to the predetermined threshold, aggregate the corresponding numerical facial feature data to generate feature description text and generate a prompt sentence comprising the feature description text;
input the prompt sentence to a text generation AI model, execute the text generation AI model to generate story content based on the plurality of numerical facial feature data, acquire emotion information indicating an emotional state of the participant, and adjust contents of at least one of the prompt sentence and the story content based on the emotion information to generate adjusted story content as presentation data; and
transmit the presentation data and the plurality of facial image data items to a virtual space display device via the communication interface so that the virtual space display device displays the adjusted story content and the plurality of facial image data items in a virtual reality space.

2. The system according to claim 1, wherein the circuitry is configured to integrate the numerical facial feature data and the emotion information as different types of feature information, generate the prompt sentence based on the integrated feature information, and input the prompt sentence to the text generation AI model so that story content reflecting the different types of feature information is generated.

3. The system according to claim 2, wherein the circuitry is configured to encode the emotion information as an emotion feature vector and concatenate the emotion feature vector with the numerical facial feature data prior to generating the prompt sentence.

4. The system according to claim 3, wherein the circuitry is configured to generate a plurality of candidate prompt sentences by varying weighting parameters applied to the emotion feature vector and the numerical facial feature data, and select a candidate prompt sentence based on a predicted content coherence score.

5. The system according to claim 4, wherein the predicted content coherence score is computed by a scoring model trained on prior pairs of prompt sentences and corresponding story content quality evaluations.

6. The system according to claim 1, wherein the circuitry is configured to transmit virtual space display data comprising the story content and the plurality of facial image data items to a virtual reality display apparatus comprising at least one of a three-dimensional image display apparatus and a head-mounted display apparatus, and cause the virtual reality display apparatus to display the story content in a time sequence.

7. The system according to claim 6, wherein the circuitry is configured to synchronize display timing of the story content with the plurality of facial image data items in the virtual reality space by generating a timing sequence that maps each portion of the story content to a corresponding subset of the facial image data items.

8. The system according to claim 1, wherein the generative AI model is conditioned on the numerical facial feature data by providing the feature vectors as input to a conditioning layer of the generative AI model prior to generating the plurality of facial image data items.

9. The system according to claim 8, wherein the generative AI model comprises a convolutional neural network trained to generate facial image data conditioned on feature vectors representing facial component configurations.

10. The system according to claim 1, wherein the emotion information is acquired from at least one of image data representing a facial expression of the participant captured by a camera device, or audio data representing speech of the participant captured by a microphone device, and wherein the circuitry applies an emotion recognition model to the acquired data to generate the emotion information.

11. The system according to claim 10, wherein the emotion recognition model applies a convolutional neural network to the image data to detect facial expression features, or applies a recurrent neural network to audio features extracted from the audio data.

12. The system according to claim 1, wherein the feature description text is generated by computing aggregate statistics over the numerical facial feature data of the stored facial image data items and converting the aggregate statistics into a natural-language description using a template-based or model-based text generation technique.

13. The system according to claim 1, wherein the circuitry is configured to update the predetermined threshold based on a count of participants connected to the system via the communication interface, scaling the threshold proportionally to the number of connected participants.

14. The system according to claim 1, wherein the facial components selectable by the participant comprise at least two of eye configuration data, nose configuration data, mouth configuration data, and facial outline data.

15. The system according to claim 14, wherein the circuitry is configured to validate the facial configuration information received from the terminal device by verifying that each selected facial component corresponds to a valid entry in a facial component library stored in the memory.

16. The system according to claim 1, wherein the circuitry is configured to log each invocation of the generative AI model and the text generation AI model in an execution log comprising the input conditioning information or prompt sentence and the corresponding output, and store the execution log in the memory.

17. The system according to claim 16, wherein the circuitry is configured to retrieve a prior execution log entry having similar numerical facial feature data or emotion information, and use the prior story content as a seed input to the text generation AI model to generate a contextually consistent new story content.

18. A system comprising:
circuitry configured to:
receive facial configuration information from a terminal device via a communication interface, encode the facial configuration information as numerical facial feature data, and generate a plurality of facial image data items using a generative AI model conditioned on the numerical facial feature data;
determine when a count of stored facial image data items reaches a predetermined threshold, aggregate the numerical facial feature data to generate feature description text, and construct a prompt sentence incorporating the feature description text;
input the prompt sentence to a text generation AI model to generate story content, acquire emotion information representing an emotional state of a participant, and adjust the story content based on the emotion information to generate presentation data; and
transmit the presentation data and the facial image data items to a virtual space display device via the communication interface for display in a virtual reality space.

19. The system according to claim 18, wherein the circuitry is configured to encode the emotion information as an emotion feature vector, integrate the emotion feature vector with the numerical facial feature data to generate a unified feature representation, and generate the prompt sentence based on the unified feature representation.

20. A method comprising:
causing a terminal device to provide a user interface that allows a participant to select facial components and combine the facial components to generate facial configuration information via a communication interface coupled to a packet-switched network, receiving the facial configuration information as structured data from the terminal device, encoding the structured data as numerical facial feature data, and storing the numerical facial feature data as feature vectors in a memory;
inputting the numerical facial feature data as conditioning information together with random information to a generative AI model, executing the generative AI model to generate a plurality of facial image data items similar to the numerical facial feature data, and storing the plurality of facial image data items and corresponding numerical facial feature data in the memory;
determining whether a number of the facial image data items stored in the memory is greater than or equal to a predetermined threshold and, when the number is greater than or equal to the predetermined threshold, aggregating the corresponding numerical facial feature data to generate feature description text and generating a prompt sentence comprising the feature description text;
inputting the prompt sentence to a text generation AI model, executing the text generation AI model to generate story content based on the plurality of numerical facial feature data, acquiring emotion information indicating an emotional state of the participant, and adjusting contents of at least one of the prompt sentence and the story content based on the emotion information to generate adjusted story content as presentation data; and
transmitting the presentation data and the plurality of facial image data items to a virtual space display device via the communication interface so that the virtual space display device displays the adjusted story content and the plurality of facial image data items in a virtual reality space.
